(19) United States
(12) Patent Application Publication
(10) Pub. No.: US 2015/0310751 A1
(43) Pub. Date: Oct. 29, 2015

(54) AUGMENTED REALITY ASSISTED EDUCATION CONTENT CREATION AND MANAGEMENT

(71) Applicant: Indu Tolia, North Brunswick, NJ (US)

(72) Inventor: Indu Tolia, North Brunswick, NJ (US)

(21) Appl. No.: 14/695,931

(22) Filed: Apr. 24, 2015

Related U.S. Application Data
(60) Provisional application No. 61/983,498, filed on Apr. 24, 2014.

(51) Int. Cl. G09B 5/06

(52) U.S. Cl. CPC G09B 5/06

(57) ABSTRACT

A computer implemented method for generating educational content is provided for. This method employs a memory that stores computer-executable instructions, as well as a processor, both of which are communicatively coupled to the memory that facilitates execution of the computer-executable instructions. Preferably, the instructions are providing, a collaborative project tracking system then preparing, a lesson aligned with a standardized education model. After that, the method moves to creating an animated augmented lesson and subsequently developing, a lesson, where this lesson is constructed from a pre-determined template. After the lesson is made at least one trigger element is generated, where this trigger element links a content object with a lesson in a manner that provides for an animated augmented lesson.

### CLAIM OF PRIORITY

This application claims priority from U.S. Provisional Patent Application No. 61/983,498, filed on Apr. 24, 2014, the contents of which are hereby incorporated by reference.

### FIELD OF THE EMBODIMENTS

The method and system disclosed herein, in general, relates to teaching aids that assist in clarifying or enlivening a subject. More particularly, the method and system disclosed herein relates to augmented reality assisted teaching aids for enhancing the overall learning experience of students.

### BACKGROUND OF THE EMBODIMENTS

Education reform is a top concern in America today. Reports of disparate resources, caliber of teachers, and available funding highlight the vast inequality in American education. A number of solutions have been proposed, however, one such solution is gaining significant traction. This solution is the implementation of standardized education criteria. That is, for a student at a grade level in a certain course, there are certain skills and benchmarks that these students are expected to develop and meet. One popular standard is the Common Core State Standards Initiative.

The Common Core has been widely praised, however its implementation has been fickle at best. School districts are now predicating funding based on performance with regard to these standards. With this requirement, teachers are more and more “teaching to the tests” mandated by this, and similar programs. This practice leads to a distinct lack of innovation in the classroom, further exacerbating the problem that caused these standards to be implemented in the first place.

Review of related technology:

United States Patent Publication No.: 2014/0267792 relates to a contextual local image recognition module of a device retrieves a primary content dataset from a server and then generates and updates a contextual content dataset based on an image captured with the device. The device stores the primary content dataset and the contextual content dataset. The primary content dataset comprises a first set of images and corresponding virtual object models. The contextual content dataset comprises a second set of images and corresponding virtual object models retrieved from the server.

United States Patent Publication No.: 2014/0354532 relates to a system and method for manipulating a virtual object based on intent is described. A reference identifier from a physical object is captured. The reference identifier is communicated via a network to a remote server. The remote server includes virtual object data associated with the reference identifier. The virtual object data is received at the computing device. The virtual image is displayed in a virtual landscape using the virtual object data. In response to relative movement between the computing device and the physical object caused by a user, the virtual image is modified. Brain activity data of the user is received. A state of the virtual object in the virtual landscape is changed based on the brain activity data.

United States Patent Publication No.: 2014/0267408 relates to a server that receives and analyzes analytics data from an application of one or more devices. The application corresponds to a content generator. The server generates, using the content generator, a visualization content dataset based on the analysis of the analytics data. The visualization content dataset comprises a set of images, along with corresponding analytics virtual object models to be engaged with an image of a physical object captured with the one or more devices and recognized in the set of images. The analytics data and the visualization content dataset may be stored in a storage device of the server.

United States Patent Publication No.: 2014/0267407 relates to a system and method for segmentation of content delivery is described. A virtual object model is divided into a plurality of segments. An order of the plurality of segments is arranged in a delivery queue. Each segment of the virtual object model is delivered in the order of the delivery queue to a device that is configured to recognize a physical object that is associated with the virtual object model.

United States Patent Publication No.: 2014/0267405 relates to a server for campaign optimization is described. An experience content dataset is generated for an augmented reality application of a device based on analytics results. The analytics results are generated based on analytics data received from the device. The experience content dataset is provided to the device. The device recognizes a content identifier of the experience content dataset and generates an interactive experience with a presentation of virtual object content that is associated with the content identifier.

Various devices are known in the art. However, their structure and means of operation are substantially different from the present invention. Accordingly, there is a need to help teachers implement the standards dictated by the Common Core and similar programs, while allowing them to continually innovate in how their students are being instructed. At least one embodiment of this invention is presented in the drawings below and will be described in more detail herein.

### SUMMARY OF THE EMBODIMENTS

The present invention provides for computer implemented method for generating educational content, comprising memory that stores computer-executable instructions; and a processor, communicatively coupled to the memory that facilitates execution of the computer-executable instructions comprising the steps: providing, a collaborative project tracking system; preparing, a lesson aligned with a standardized education model; creating, an animated augmented lesson, having at least one developed educational content object; developing, a lesson, wherein said lesson is constructed from a pre-determined template; generating at least one trigger element, wherein said trigger element links said at least one developed educational content object with said animated augmented lesson and said lesson, such that said linking provides for said animated augmented lesson to be overlaid said lesson, and a pre-determined manner.

The present invention also provides for a method of displaying educational content, comprising the steps of: receiving, at least one item of educational media content, a set of criteria, and optionally an update to said at least one item of educational media content; developing, at least one educational content object using said received educational media content; generating, a trigger element for each of said at least one item of educational media content; receiving, said trigger element and said at least one developed educational object from said content development application via an augmented reality application; receiving, at least one item of additional information; generating, media assets from said at least one developed educational content object and said at least one item of additional information; creating, at least one item of augmented educational content; displaying, said at least one item of augmented educational content, via an augmented reality display device.

The present invention further provides for a augmented educational content management system, comprising: at least one item of educational media content; updates to said at least one item of educational media content, if available; a set of educational criteria; a content development application, wherein said content development application is capable of receiving said at least one item of educational media content, said updates to said at least one item of educational media content, and set of educational criteria, and wherein said content development application is capable of generating at least one educational content object, at least one trigger element capable of assessing to at least one associated developed educational content object; an augmented reality application, wherein said augmented reality application is capable of receiving said at least one educational content object, at least one trigger element, at least one associated developed education content object, and at least one item of additional information, wherein said augmented reality application is also capable of generating at least one media asset based on said at least one educational content object, at least one trigger element, at least one associated developed education content object, and said at least one item of additional information; at least one item of augmented educational content, generated from said at least one media asset; and an augmented reality display device, capable of displaying said at least one item of augmented educational content.

A computer implemented method for creating and managing augmented education content is provided. The computer implemented method disclosed herein employs an augmented education content management system comprising of one or more processors configured to execute computer program instructions for creating and managing augmented education content. The augmented education content management system comprises of the content developed by a content development application executable by one or more devices. The content development application receives educational media content, updates to the educational media content, and educational criteria associated with the educational media content from one or more education sources. The educational media content comprises, for example, one of textual content, audio content, audiovisual content, image content, multimedia content, etc., or any combination thereof. The content development application develops one or more educational content objects using the received educational media content and the educational criteria in one or more of multiple formats. The developed educational content objects are stored in a storage device.

The content development application generates a trigger element for each of the developed educational content objects. The trigger element triggers access to an associated developed educational content object. The augmented reality application receives the trigger element and each associated educational content object from the content development application. The augmented reality application receives additional information comprising, for example, research information from one or more animation sources. The augmented reality application, in communication with one or more education sources, generates media assets using the developed educational content objects and the received additional information based on the received educational criteria. The generation of the media assets comprises programming the generated media assets to triggers and assigning interactions to these triggers. The augmented reality application creates the augmented education content in one or more formats using the generated media assets. The created augmented education content is accessible using the trigger element.

It is an object of the present invention to educate the youth of America.

It is an object of the present invention to provide a means to generate augmented educational content.

It is an object of the present invention to provide a system for displaying augmented educational content.

The following disclosure meets and exceeds those objectives.

### BRIEF DESCRIPTION OF THE DRAWINGS

FIG. 1 shows a flow chart illustrating an embodiment of the method of creation of educational content of the present invention.

FIGS. 2A-2G show exemplary embodiments of associated developed educational content of the present invention.

FIGS. 3A-3L show exemplary embodiments of augmented education content of the present invention.

FIGS. 4A-4K show how to use an embodiment of the project tracker of the present invention.

FIGS. 5A-5K show how to use an embodiment of the augmented animation lesson generator of the present invention.

FIGS. 6A-6J show an embodiment of a workflow for creating educational documents of the present invention.

FIGS. 7A-7D show an embodiment of a trigger creator of the present invention.

FIG. 8 shows an embodiment of augmented educational content of the present invention.

FIG. 9 shows a flow chart of an embodiment of the method of creating augmented educational content of the present invention.

### DETAILED DESCRIPTION OF THE INVENTION

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

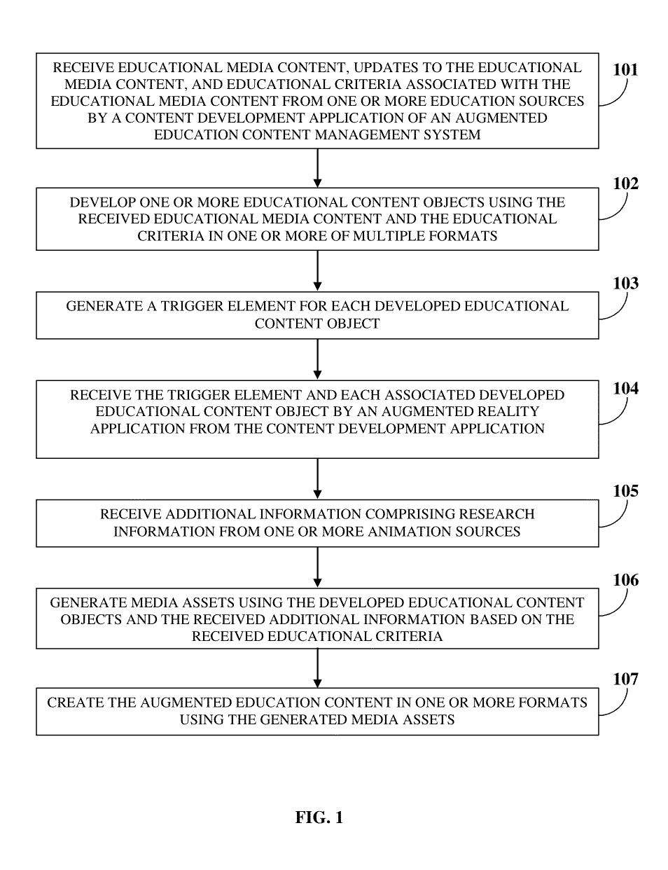

Referring to FIG. 1, a computer implemented method for creating and managing augmented education content is shown. The computer implemented method disclosed herein employs an augmented education content management system comprising one or more devices configured to execute computer program instructions for creating and managing the augmented education content. The augmented education content management system implements a fusion of augmented reality technology and self-created standards aligned supplemental educational content. The curriculum is aligned with education initiatives, instructional models, and guidelines, for example, Common Core standards, Next Generation Science standards (NCSS), Guided Language Acquisition Design (GLAD), Science, Technology, Engineering, and Mathematics (STEM) guidelines, Science, Technology, Engineering, Art, and Mathematics (STEAM) guidelines, etc. The augmented education content management system provides augmented reality supplemental lessons, augmented reality animated lessons for review or reteach, augmented workbooks, 3D holographic content, etc.

The augmented education content management system is accessible to users, for example, administrators, educators, students, children, adults, animators, and parents or guardians through a broad spectrum of technologies and devices such as personal computers, smart devices, tablet computing devices, etc. The augmented education content management system allows a team of qualified educators and animators to create a whole suite of augmented lessons, as well as worksheets that are aligned with the mandated common core standards. For example, in order to create educational media content for the augmented education content, an education source, herein referred to as an “educator”, reviews and/or reads the common core standards, the next generation science standards, and/or science, technology, engineering, and mathematics (STEM) guidelines, and/or science, technology, engineering, art, and mathematics (STEAM) guidelines. The educator also views additional standards or educational content guidelines based on the project in a printed version or from a specified website, for example, www.corestandards.org, www.nextgenscience.org/next-generation-science-standards, etc. The educator applies background knowledge, personal credentials, and experience to the given standard grades, for example, preschool through twelfth grade as well as higher education and adult education for mathematics, English language arts, social studies, science, special education, English as a second language, and English language learners, various electives, standardized assessments such as Partnership for Assessment of Readiness for College and Careers (PARCC), Scholastic Assessment Test (SAT), General Education Development (GED), etc. The educator further references various texts and outside resources to build their knowledge to begin creating the educational media content.

The educator opens and begins developing educational media content within a presentation software, herein referred to as a “content development application”, implemented, for example, as a web based software or a standalone software and integrated within the augmented education content management system. The content development application builds the educational media content into a lesson and/or re-teach and/or review format for users, for example, administrators, educators, students, children, adults, and parents or guardians. The educator then reviews and edits the created educational media content within the content development application. The educator further reads and speaks the lesson aloud into a digital recorder. The recordings in the digital recorder are of various lengths depending on the educational media content. The educator then connects or plugs the digital recorder into the computing device and uploads the recorded file. The educator opens a word document software integrated within the augmented education content management system. The educator provides titles for the documents created using the word document software and formats the documents appropriately. The educator then reviews and edits the created educational media content within the word document software.

The augmented education content management system comprises of the content developed by a content development application executable by one or more devices. The content development application receives 101 the educational media content, updates to the educational media content, and educational criteria associated with the educational media content from one or more education sources. The updates comprise reviews and edits to the educational media content. The educational media content comprises textual content, audio content, audiovisual content, image content, multimedia content or any combination thereof. The educational criteria comprises, for example, educational standards and guidelines, references, background information, resource information, format information, grade layout themes, visualizations required, and personal information.

The content development application develops 102 one or more educational content objects using the received educational media content and the educational criteria in one or more of multiple formats. The educational content objects are also referred to herein as “supplemental materials”. The augmented education content management system provides the educational content objects to users to reinforce and enhance key concepts and academic vocabulary. The educational content objects comprise, for example, multiple worksheets, quizzes, formative assessments, summative assessments, cumulative assessments, virtual lab materials, activity sheets, flash cards and all corresponding answer keys, etc. In an embodiment, the educational content objects also include supplemental materials contrived for the augmented reality assisted animation application which is a three-dimensional (3D) educational software application such as an augmented reality based 3D educational software. The content development application allows the educator to develop the educational content objects or the supplemental materials by applying the educator's background knowledge, personal credentials, and various references that align with the specific educational media content the educator is working on. The developed educational content objects are stored in a storage device, for example, a cloud-based storage, a server, a flash-drive, a jump drive or other media storage device.

The content development application generates 103 a trigger element for each of the developed educational content objects. For example, the educator works with an animator to take a snapshot of the title screen from the presentation software integrated within the augmented education content management system to use as a trigger image to be placed on some of the supplemental materials or the developed educational content objects. The animator creates a clear title screen for each lesson to later be used as a trigger for augmented reality assisted animation application and worksheets or educational content objects. Additional educators will review their team member's or the initial educator's educational content object, offer feedback, and work with the animators on a loop revision process to finalize the educational content objects. The initial educator reviews all the educational content objects and finalizes each individual educational content object into the storage device. The trigger element triggers access to one associated developed educational content object. The trigger element is, for example, an image, a link, an icon or any element that can trigger a developed educational content object. The trigger image and exported presentation content is then loaded into the augmented reality application of the augmented education content management system.

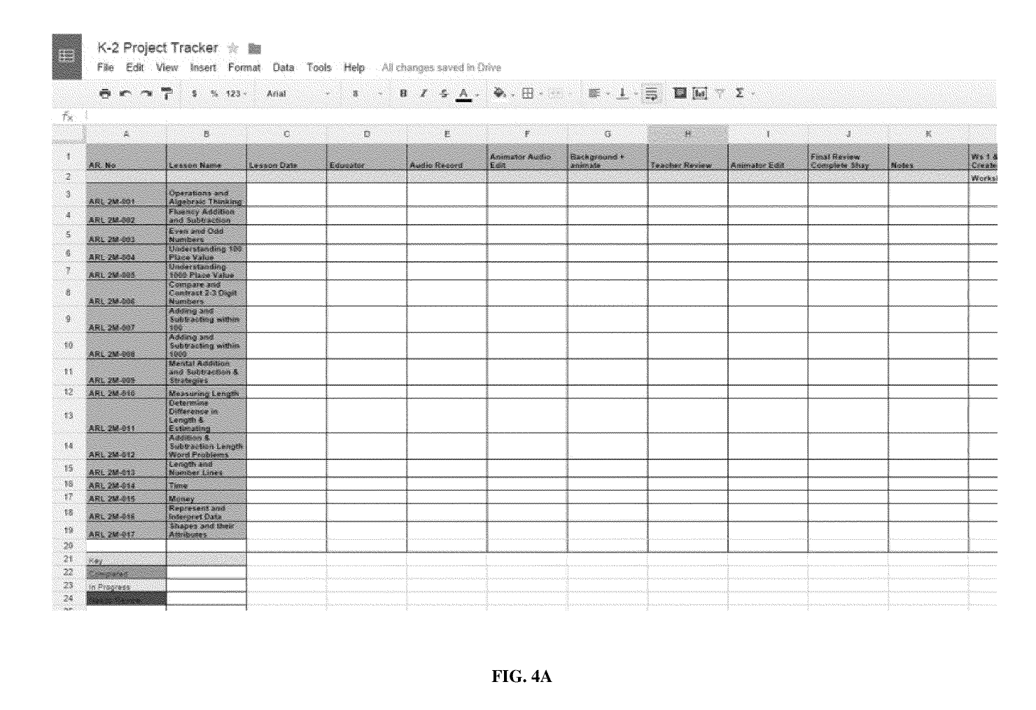

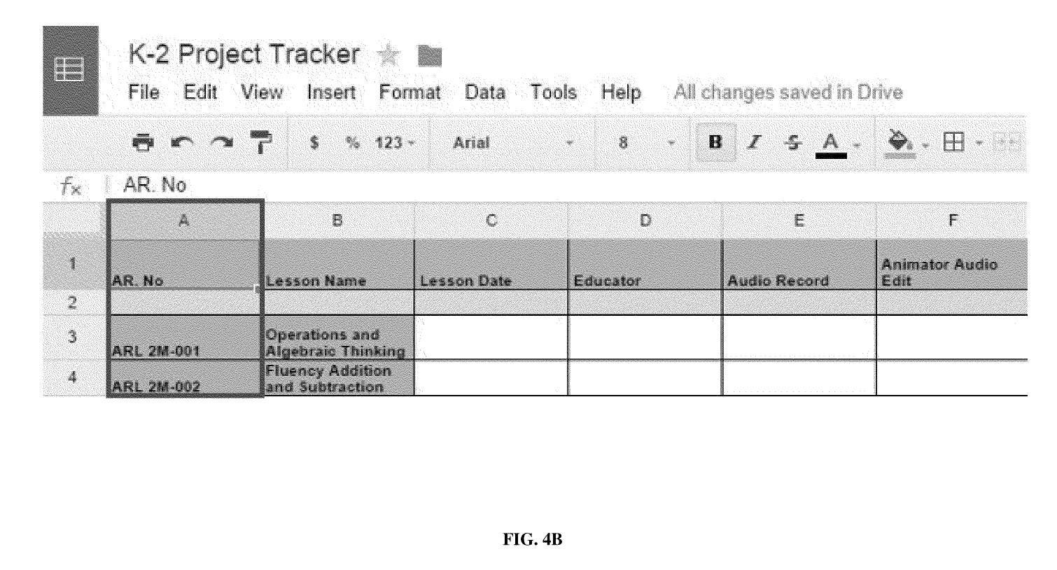

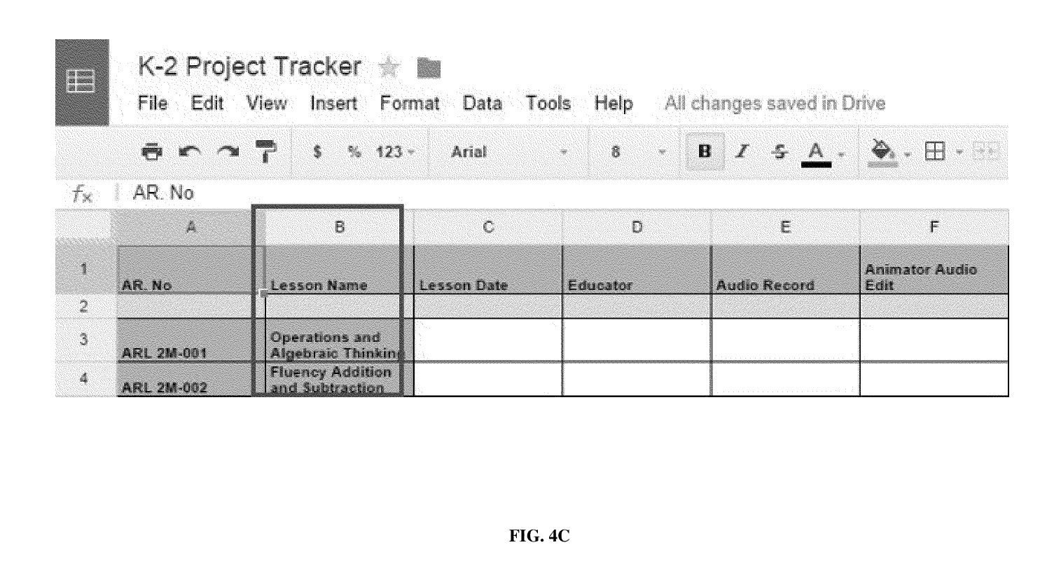

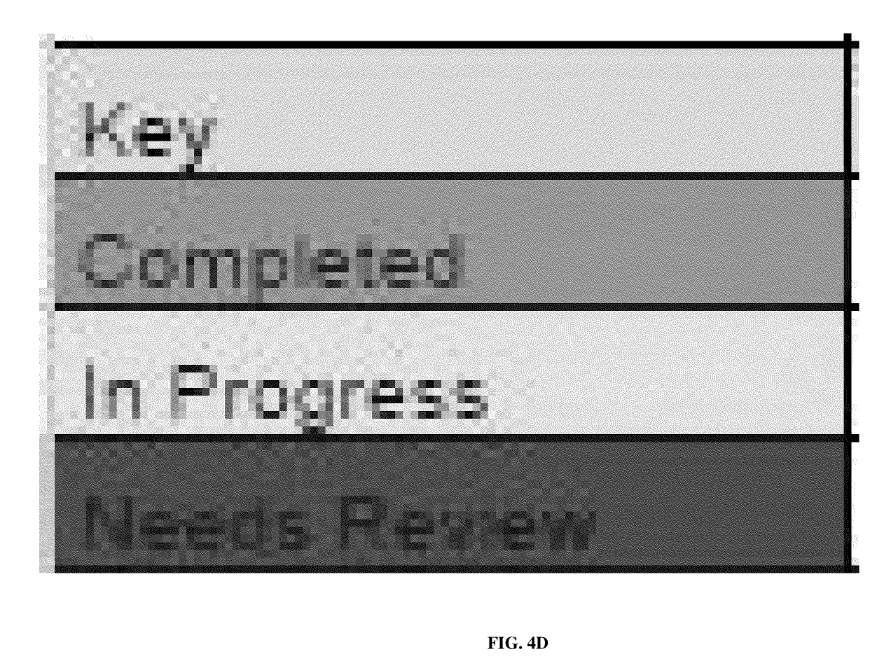

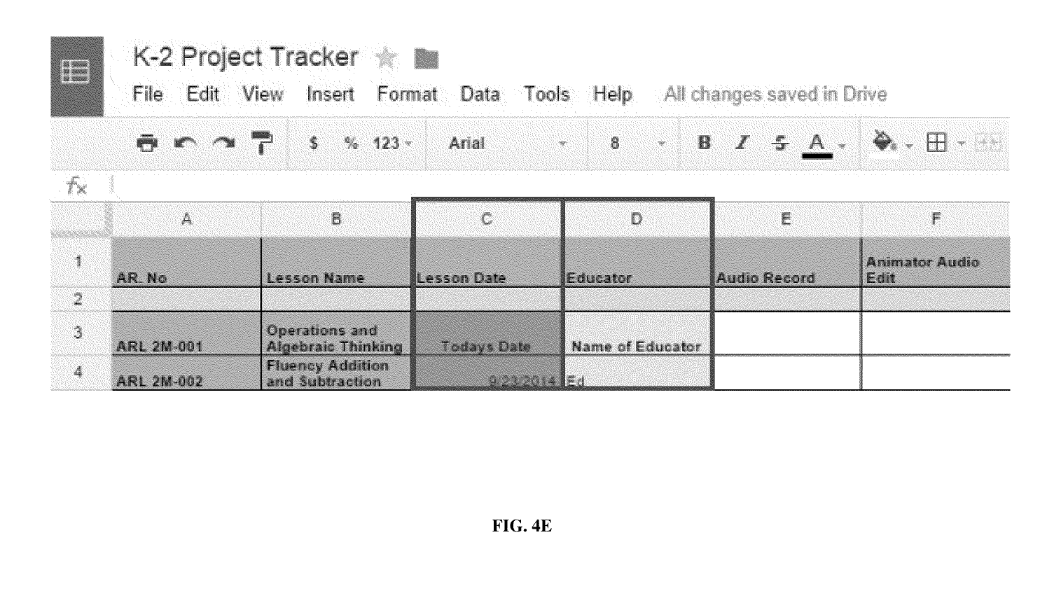

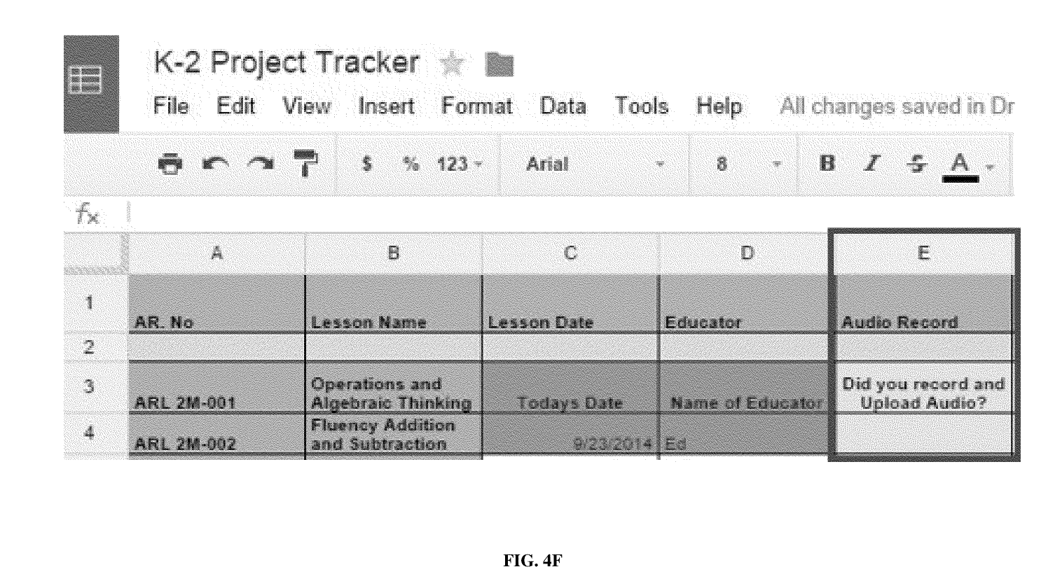

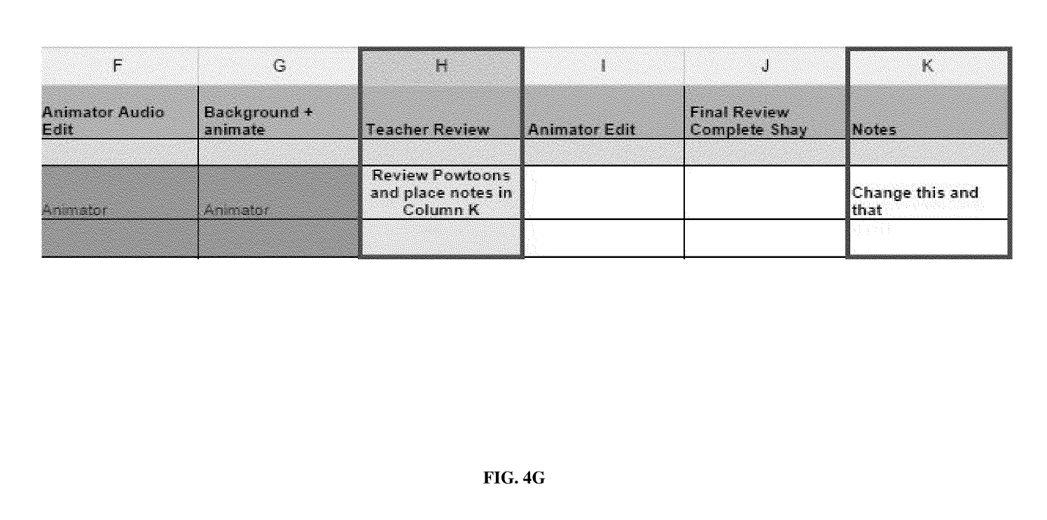

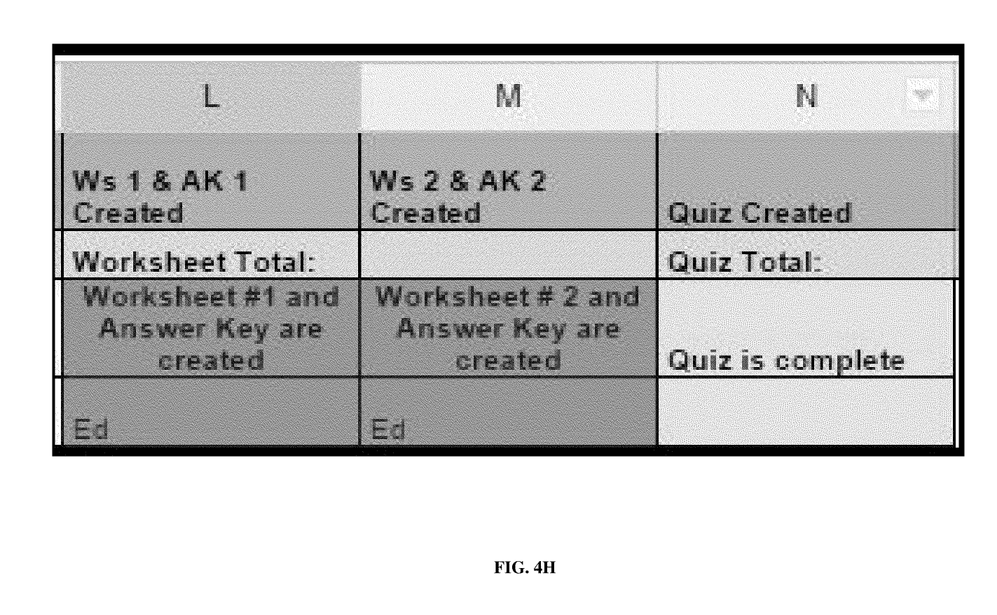

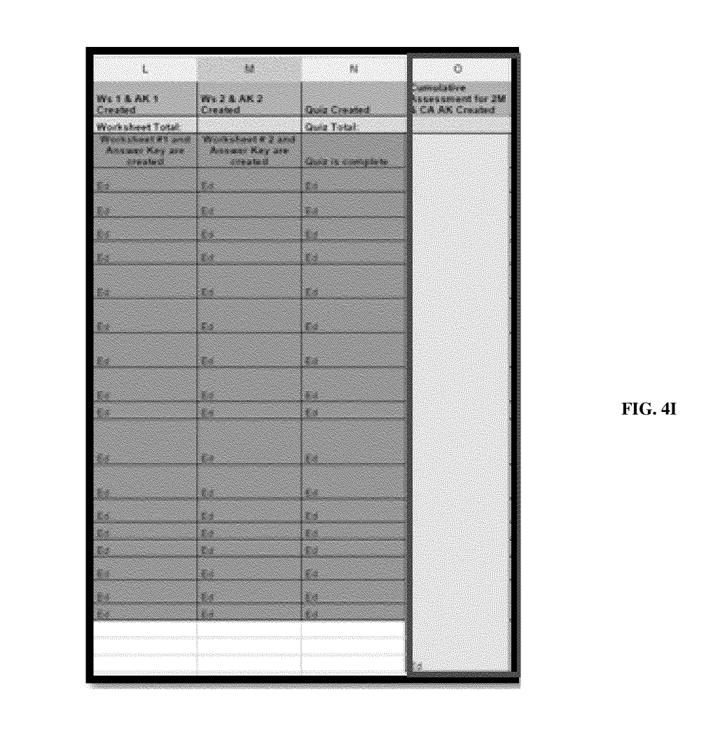

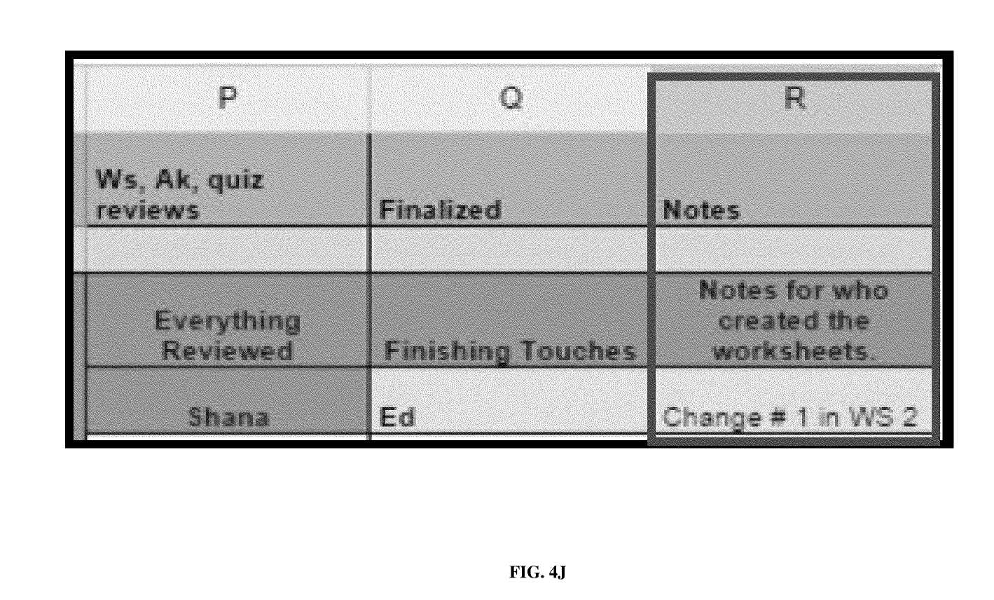

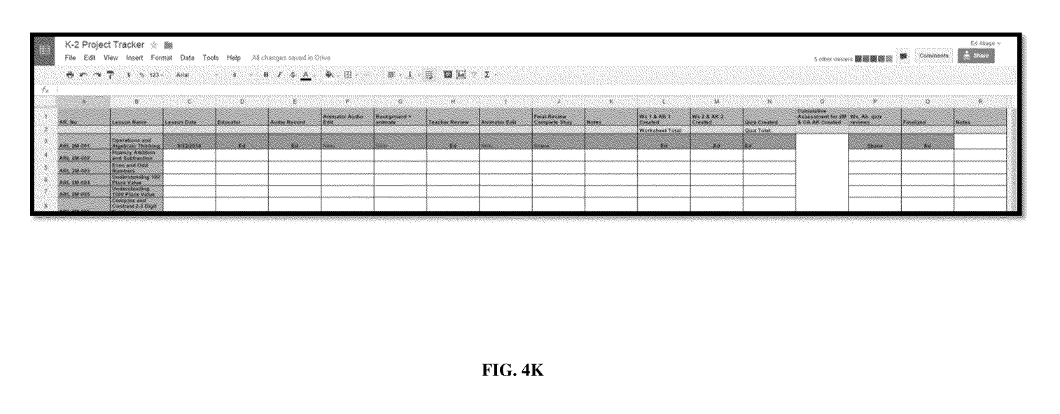

The augmented reality application receives 104 the trigger element and each associated developed educational content object from the content development application. The augmented reality application receives 105 additional information comprising research information from one or more animation sources. The augmented reality application, in communication with one or more education sources, generates 106 media assets using the developed educational content objects and the received additional information based on the received educational criteria. The generation of the media assets comprises programming the generated media assets to triggers and assigning interactions to the triggers. See FIG. 4 for explanation of how assets are programmed to triggers and how interactions are assigned to triggers.

The augmented reality application allows animation sources, herein referred to as “animators” to create assets on a need basis according to what visualizations the educators foresee necessary for work sheets, animated lessons and the virtual labs along with promotional material and any graphics for the augmented education content management system's overall identity. The animators research non-academic materials as required per project. Animators take the educator created lessons and/or educational content objects with matching recorded audio and edit them using motion graphics, vector graphics, and audio editing software integrated within the augmented education content management system. The animators edit these educational content objects to be audio synced, clear, and visually appealing animations of various lengths that are aesthetically pleasing, educational, meet standards, and cohesively match mapped out grade layout themes. The animator cross edits the finished lessons created by other animators iteratively for any oversights or mistakes in alignment, visual pops, typos, etc., followed by educator reviews.

The augmented reality application creates 107 the augmented education content in one or more formats using the generated media assets. The animator exports animations from the motion graphics, vector graphics, and audio editing software. Using the augmented reality application, the animator ties the trigger image to the uploaded animated lessons. The animator provides the trigger image to educators to insert in worksheets before publishing. All files and/or assets are exchanged between educators and animators via the storage devices. The created augmented education content in one or more formats comprises worksheets, quizzes, formative assessments, summative assessments, cumulative assessments, virtual lab materials, activity sheets, and flash cards and corresponding answer keys. The created augmented education content is accessible using the trigger element.

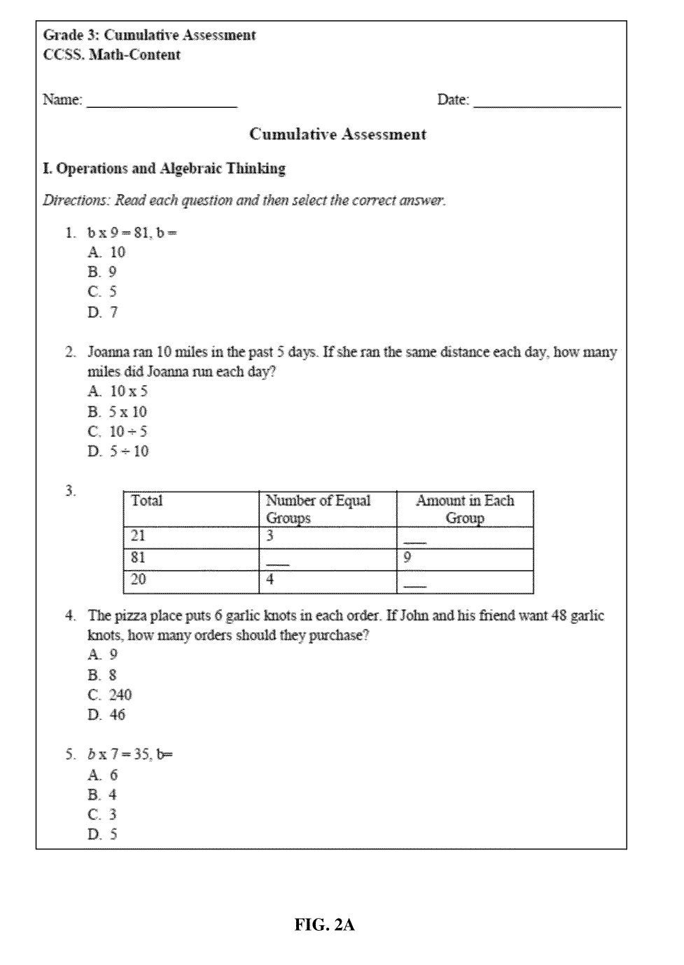

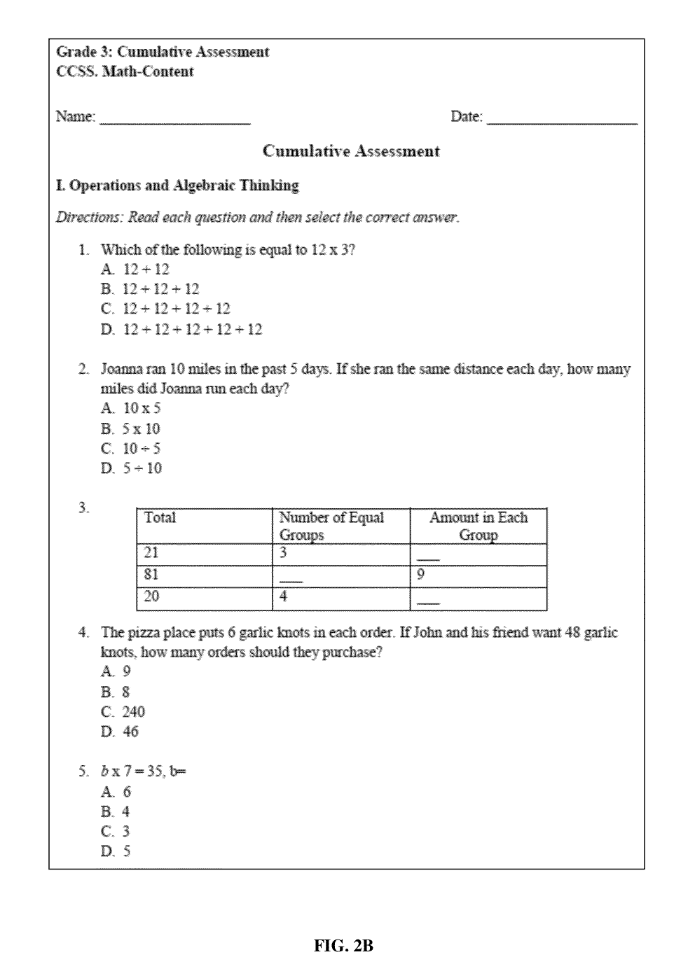

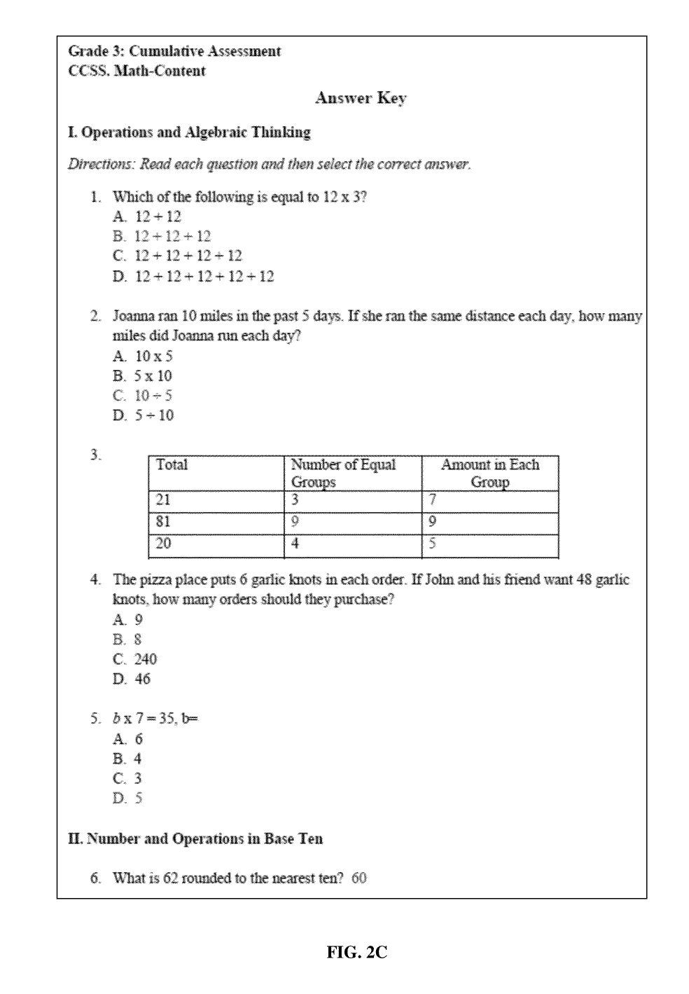

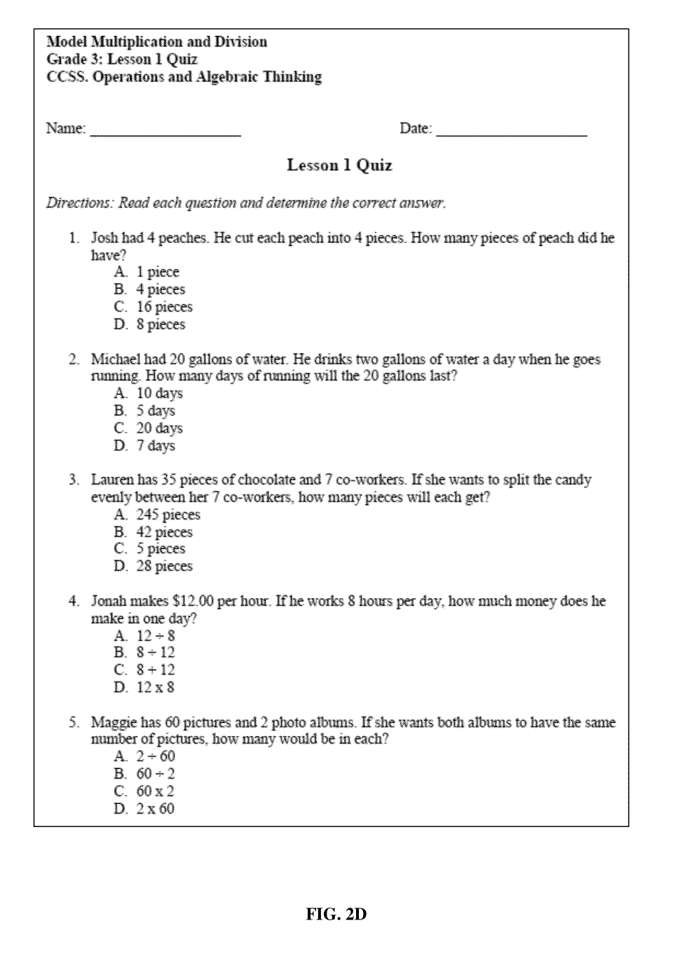

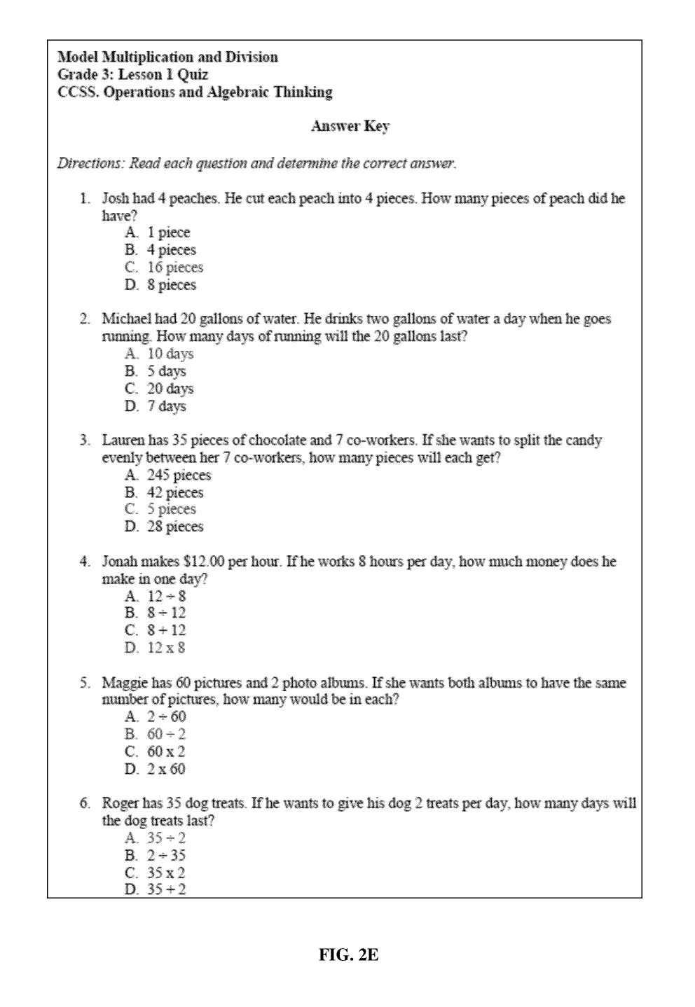

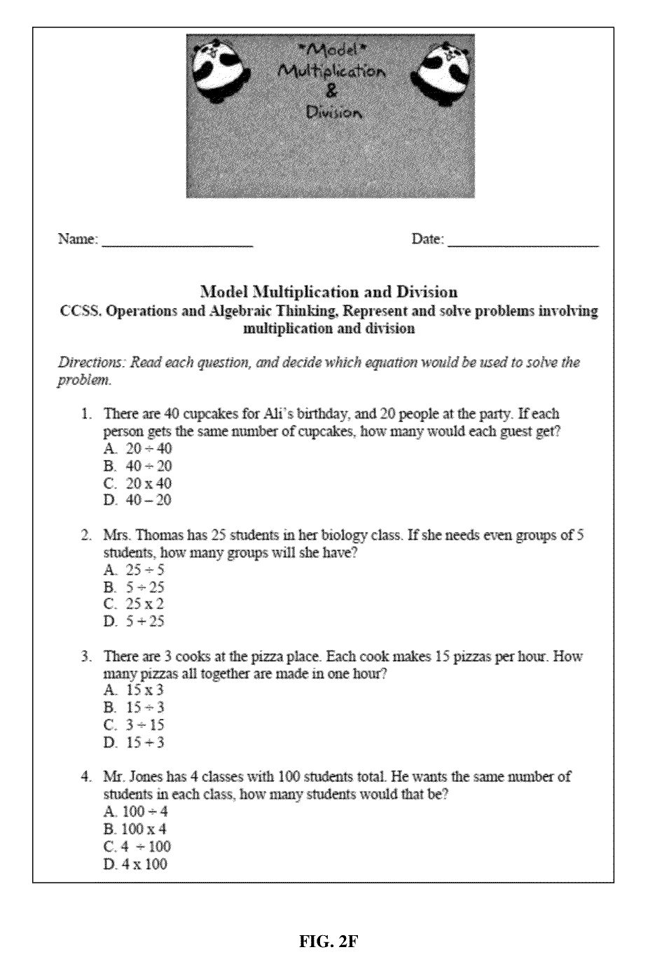

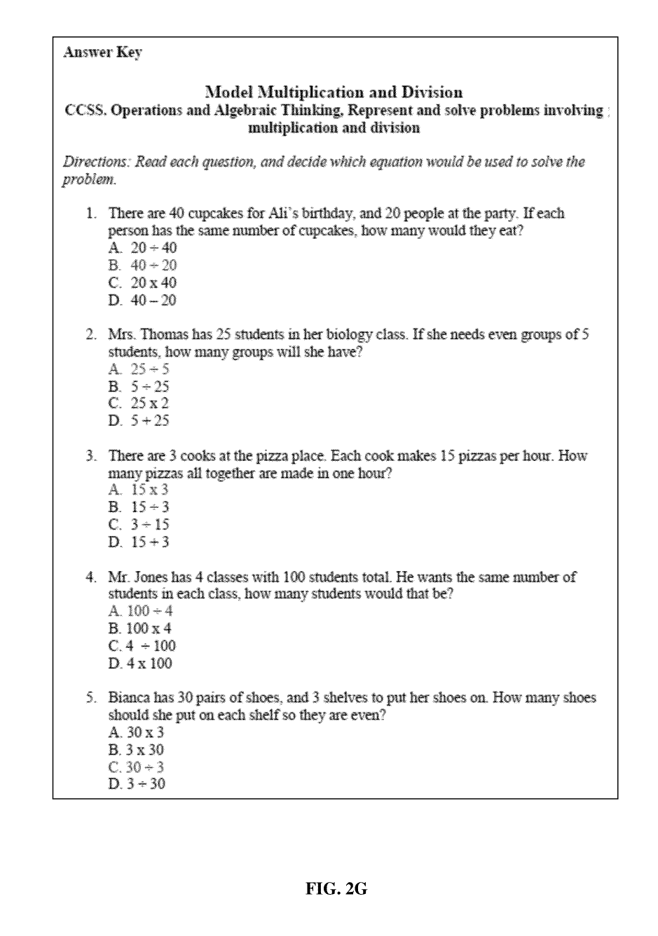

FIGS. 2A-2G exemplarily illustrate created augmented education content in different formats for use with smart devices. FIGS. 2A-2B exemplarily illustrates a cumulative assessment format on mathematics for grade 3 students. FIG. 2C exemplarily illustrates an answer key format for the cumulative assessment format exemplarily illustrated in FIG. 2B. FIG. 2D exemplarily illustrates a quiz format on operations and algebraic thinking for grade 3 students. FIG. 2E exemplarily illustrates an answer key format for the quiz format exemplarily illustrated in FIG. 2D. FIG. 2F exemplarily illustrates a model multiplication and division format on operations and algebraic thinking. FIG. 2G exemplarily illustrates an answer key format for the model multiplication and division format exemplarily illustrated in FIG. 2E.

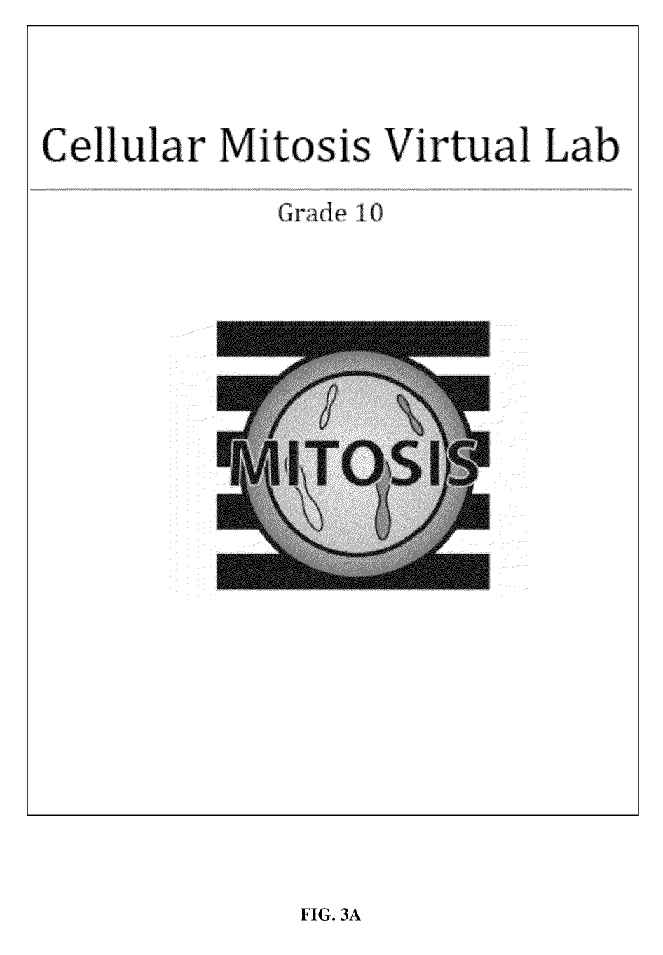

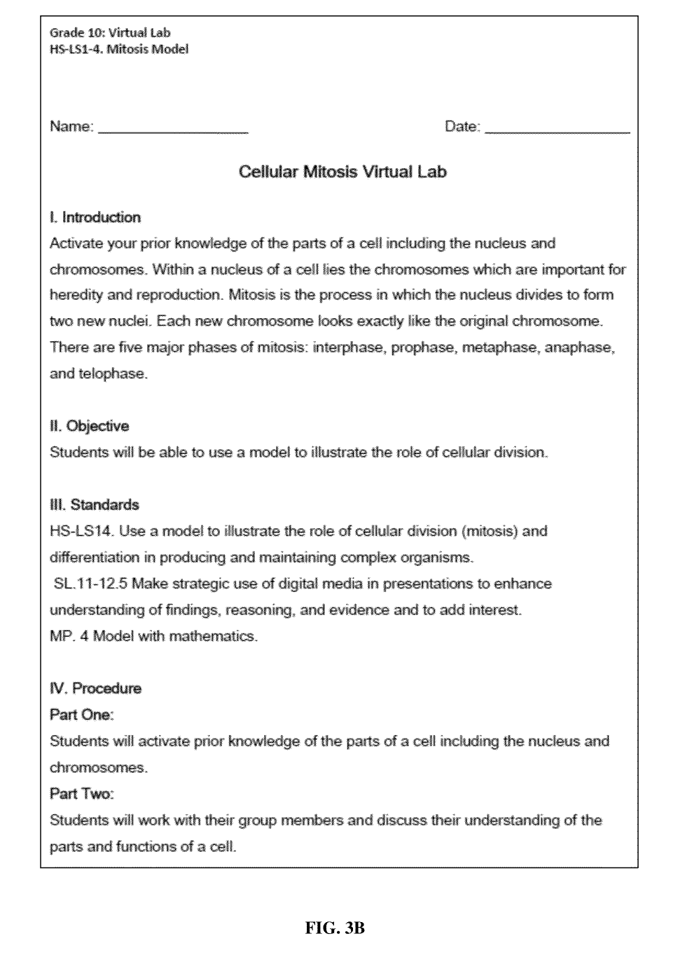

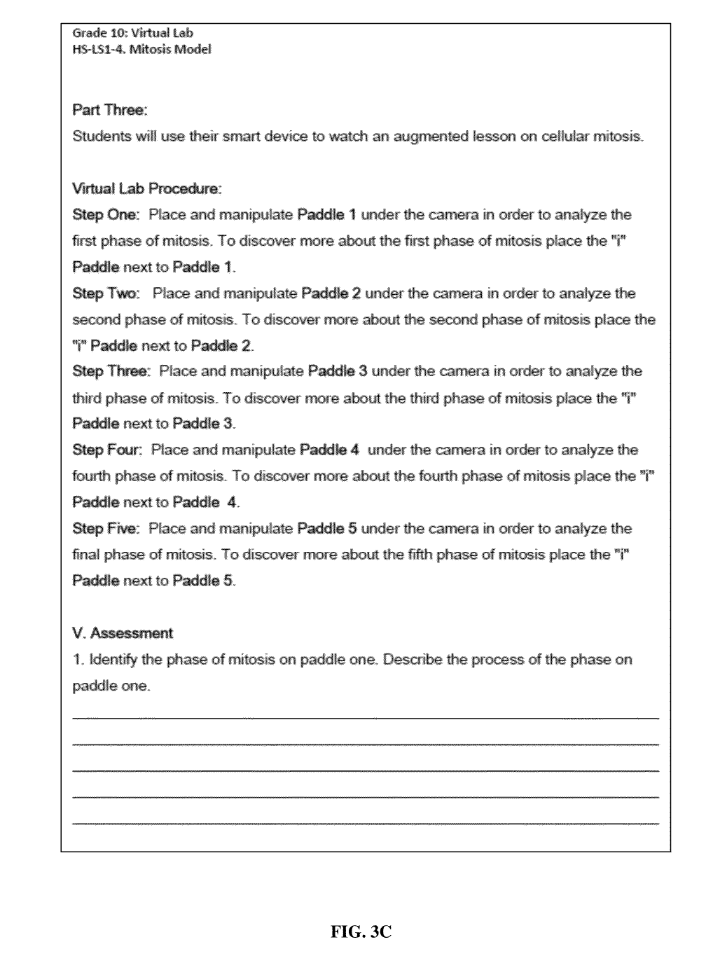

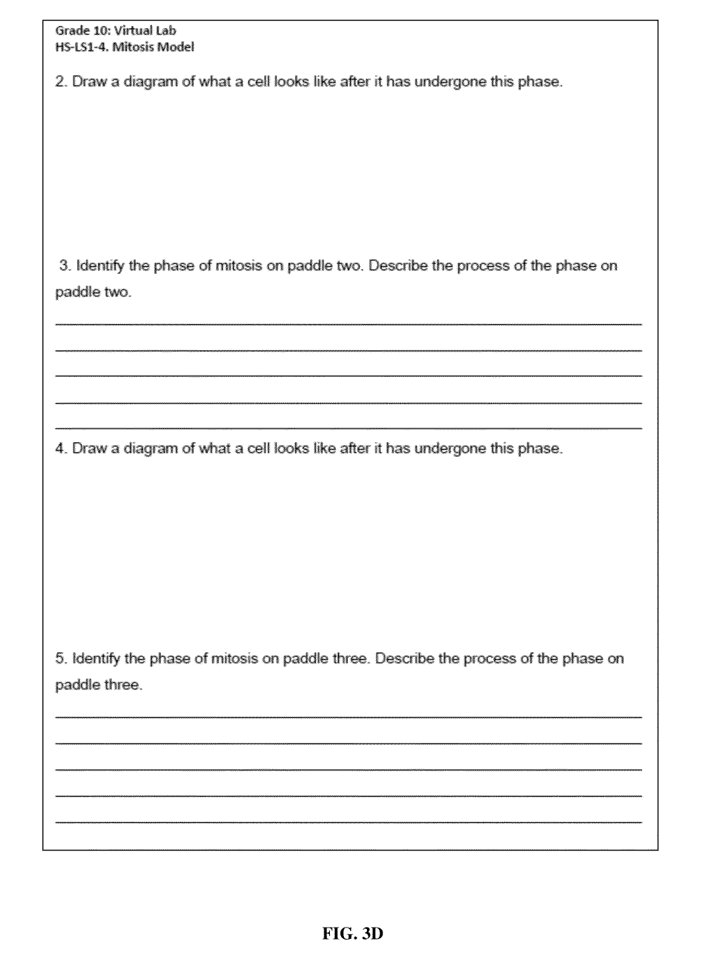

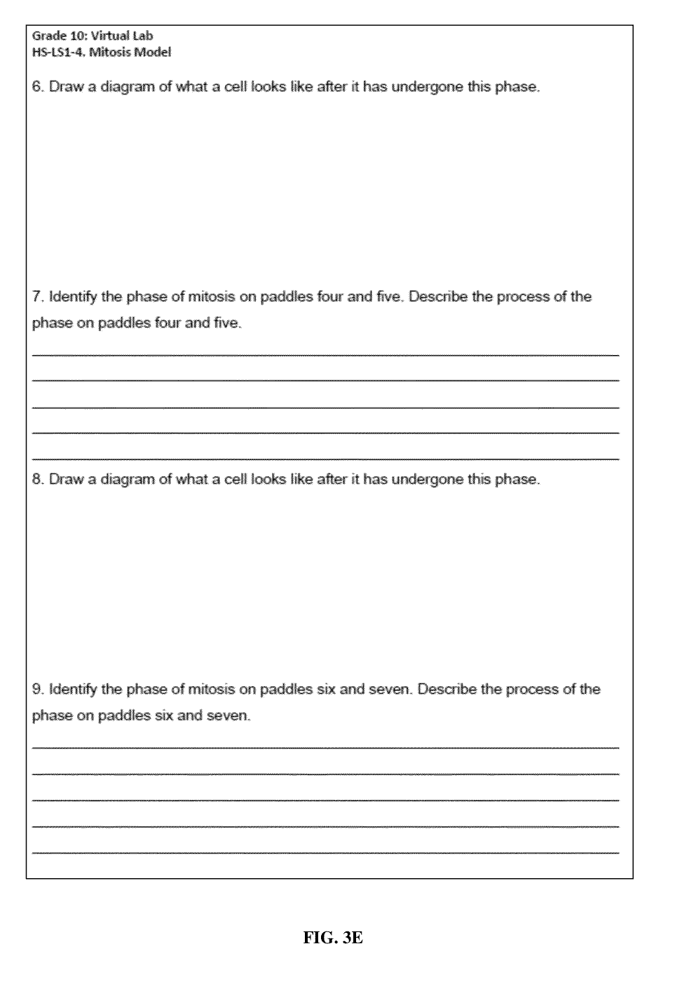

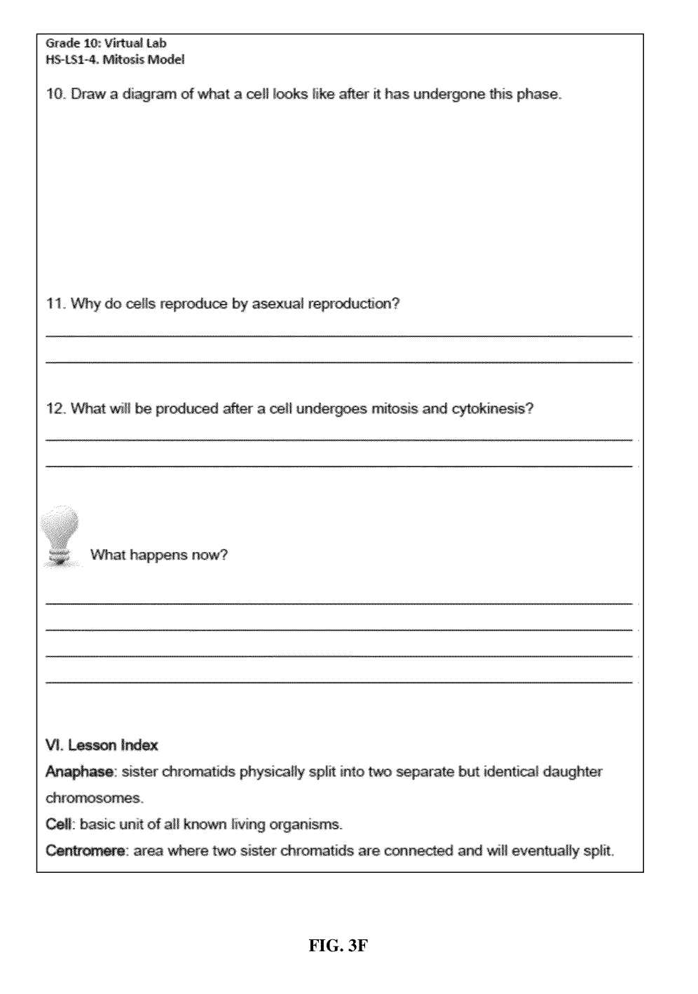

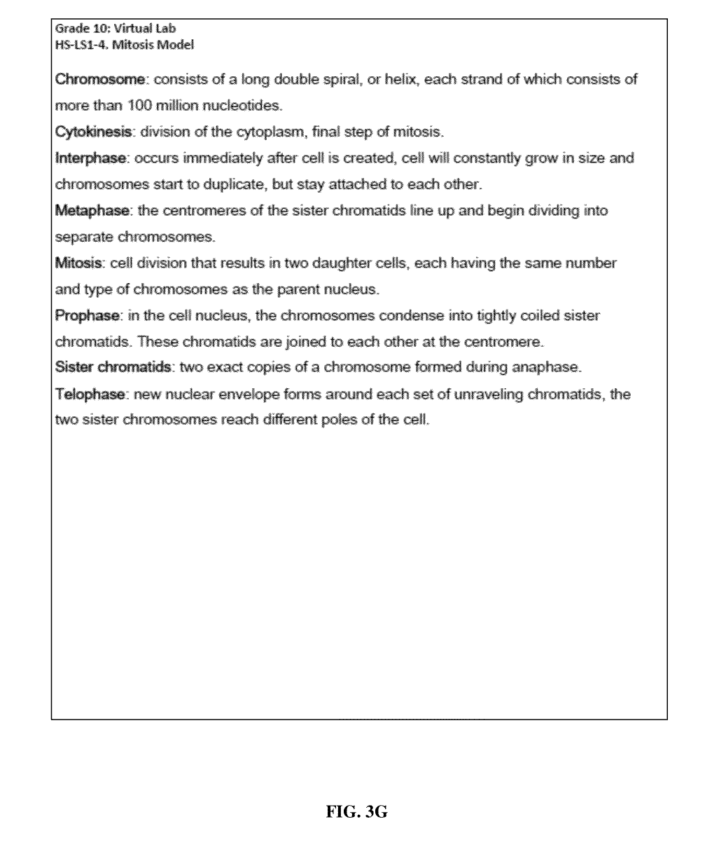

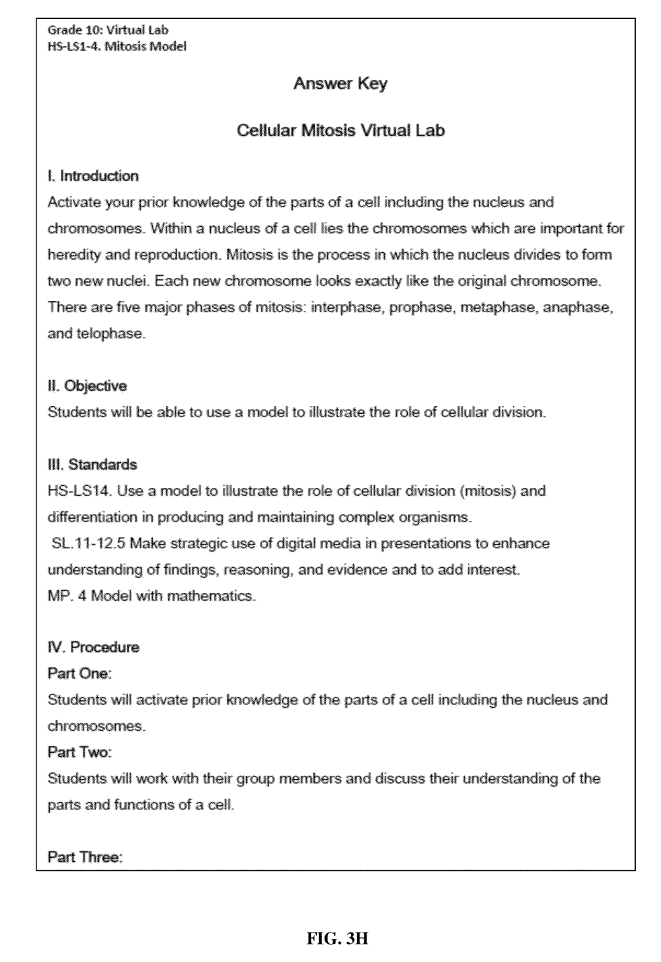

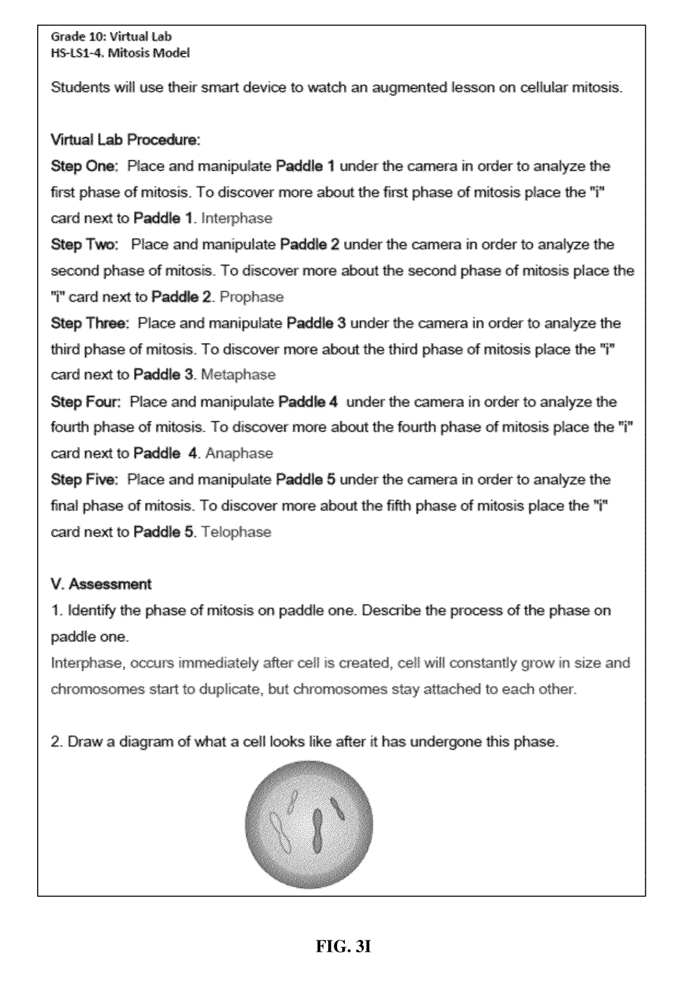

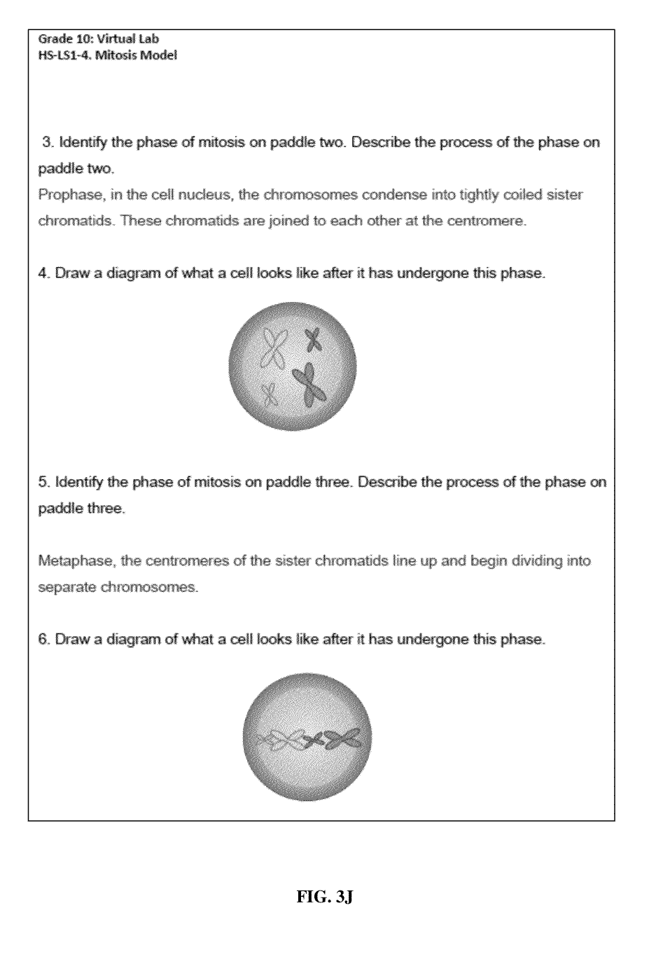

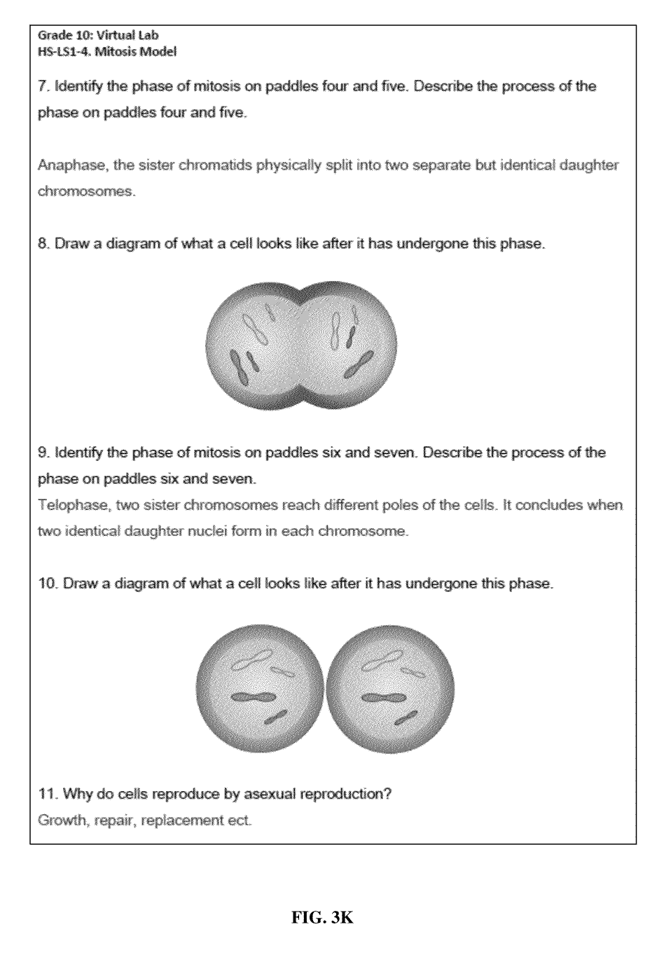

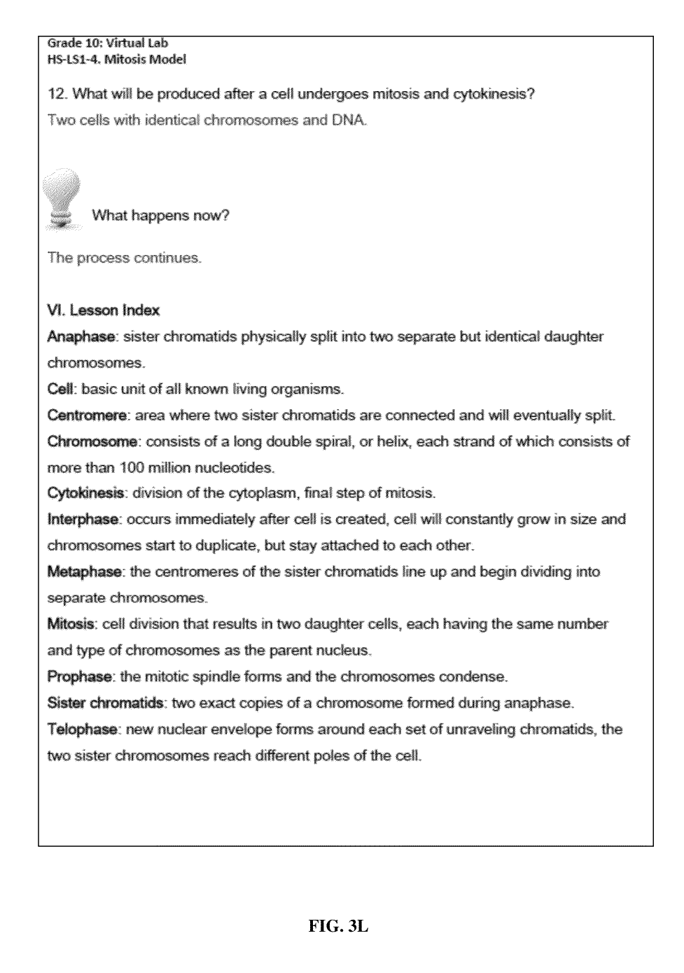

FIGS. 3A-3L exemplarily illustrate augmented education content created by the augmented education content management system in a virtual lab material format. The augmented education content management system provides an augmented reality education software or augmented reality education application, also referred herein as “virtual labs”. For operational purposes, it is assumed that the user is equipped with necessary software and hardware materials to effectively utilize the supplemental education content or the augmented education content for the virtual lab. It is also assumed that the user will follow given procedures and adapt to the instructional environment. The given procedures comprise, for example, instructions to use the product, lesson plans, and guides.

The animator meets with the educators to discuss content for the virtual labs and together creatively problem solve how to best pair visualizations and educational content for the augmented reality based 3D holographic educational interactive virtual labs. The animator and the educators then create an outline and/or a plan of action for a virtual labs based discussion. Additionally, the animator researches any additional information needed to complete the virtual labs. The animator compiles and creates assets using a third party software, for example, a photo editing, 3D modeling, and animating software. The animator then uploads assets into the augmented reality assisted animation application configured as an augmented reality lab software, programs assets to paddles, and assign interactions to the paddles. The animators demonstrate, test, and implement any and necessary changes in order to create a virtual lab that meets the educational criteria.

The augmented education content management system provides quality education content for advancing student achievements and enhancing their overall learning experience using virtual labs, for example, 3D holographic virtual labs. Upon purchasing a license to access the augmented education content, a user can utilize various technologies to view augmented lessons that are aligned to the standards to cover key concepts and vocabulary. In an embodiment, the user is provided with a secure link to download the augmented reality application on their computing device, for example, a smart phone implementing the Android® operating system of Google, Inc., or the iOS operating system of Apple, Inc., and receive appropriate channels that grants them access to view content. In another embodiment, the user needs to print out, use provided workbooks or view the supplemental material online depending on specifics of their purchase. In another embodiment, the user holds the computing device over the trigger image on the supplemental material. The viewfinder on the augmented reality application identifies the trigger image and streams the augmented lesson onto the user's computing device.

The use of the augmented lessons from each worksheet proves as a supplemental learning piece to what a student actually learned in a classroom. The augmented education content management system allows a user to manipulate various triggers or trigger elements to build and complete the augmented education content as the case maybe. After review of a lesson, user can complete worksheets, quizzes, formative assessments, summative assessments, cumulative assessments, virtual lab materials, activity sheets or view flash cards as the case maybe. If the user is a teacher, parent, guardian or administrator, the augmented education content will be reviewed and assessed based on given materials such as answer keys and personal pedagogy.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

An example of the content creation process will now be provided. It should be contemplated that this is but once example of how content may be created under the present invention, and should not be construed to limit the application in any way whatsoever.

### 1. Project Tracker (See FIGS. 4A-4K)

Educators and Animators communicate and track progress through the Project Tracker. Communication of completed tasks, edits, and comments is done through this shared document. Each row is one lesson, and the columns represent the different stages of its progress.

Preferably, each lesson consists of an animated augmented lesson, 2 worksheets, and a formative assessment. For example, the animated augmented lesson could be creating using the Powtoon® service, and the formative assessment may take the form of a quiz.

By following the order of the columns, each educator and animator knows when their job is ready to be completed for each lesson.

For example, the real-time collaborative spreadsheet may be structured as follows:
Column (A) lists the AR number code for each individual animated augmented lesson. Note that this can be matched to an educational standard as desired.
Column (B) Lesson Name is the title of the lesson.
Column (C) Lesson Date refers to the day you start the lesson
Column (D) Educator is where the educator creating this lesson would type his or her name.
Column (E) Audio Record refers to the audio of the animated augmented lesson.
Once you have completed recording the lesson AND have uploaded the audio into an assessable database, the column would be marked green.
Columns (F) and (G) are the animators' columns. The educator would check the tracker, and once F and G are green, then they would move on to their next step.
Here animators track their progress of animating the lesson. They mark it green when animation is complete.
Column (H) Teacher Review is where the educator who created the Powtoon gets to review the 1st draft of the video with the audio included. The educator will type notes and corrections to the animator after reviewing the animation in Column K.
Column L-N, which is where the educational materials are created and tracked.
Columns (L+M) WS & AK Created [1 and 2] Refers to the creation of each worksheet and answer key. These would be marked yellow when being worked on and green when finished.
Column (N) Quiz Created refers to the quiz and answer key that would accompany both worksheets.
Column (O) refers to the Cumulative Assessment (CA) that is created for the entire grade. This is the assessment that includes questions from every lesson and standard.
Column (P) WS, AK, Quiz Reviews refers to the review of the worksheets and quiz from each lesson. Note that this step would be done by a DIFFERENT EDUCATOR, to ensure that the review is not biased. Notes from this would be placed in Column R.
Columns C-R are the stages that both the educators and animators mark. As work is tracked through the different columns, you would mark the boxes according to the KEY at the bottom of the page. Further, columns within the real-time collaborative spreadsheet may be marked green when complete, yellow while being currently worked on, and red if an unfixable issue exists. When a column is marked red, it should be accompanied with a comment stating what the unfixable problem is.

### 2. Standards

In this particular embodiment, every lesson created in the tracker is aligned to the

Common Core State Standards. The Standards document is shared and shows the Educators and Animators the Common Core Standards code, the description of each standard, the CARE AR Lesson Number, and the CARE Lesson Name. This information will be used by the team to make sure the lessons and materials are aligned to the appropriate standards it is linked to. This document is used to:
1—Check the Common Core Standard code for each lesson (CCSS Code) [Example: CCSS.ELA-Literacy.RL.2.1]
2—View the description of each lesson and make sure the animated augmented lesson and supplemental materials are aligned to the descriptions.
   [Example: Ask and answer such questions as who, what, where, when, why, and how to demonstrate understanding of key details in a text.]
3—Check the C.A.R.E. AR number AND Lesson Name [Example: ARL 2E-001, Asking and Answering Questions]

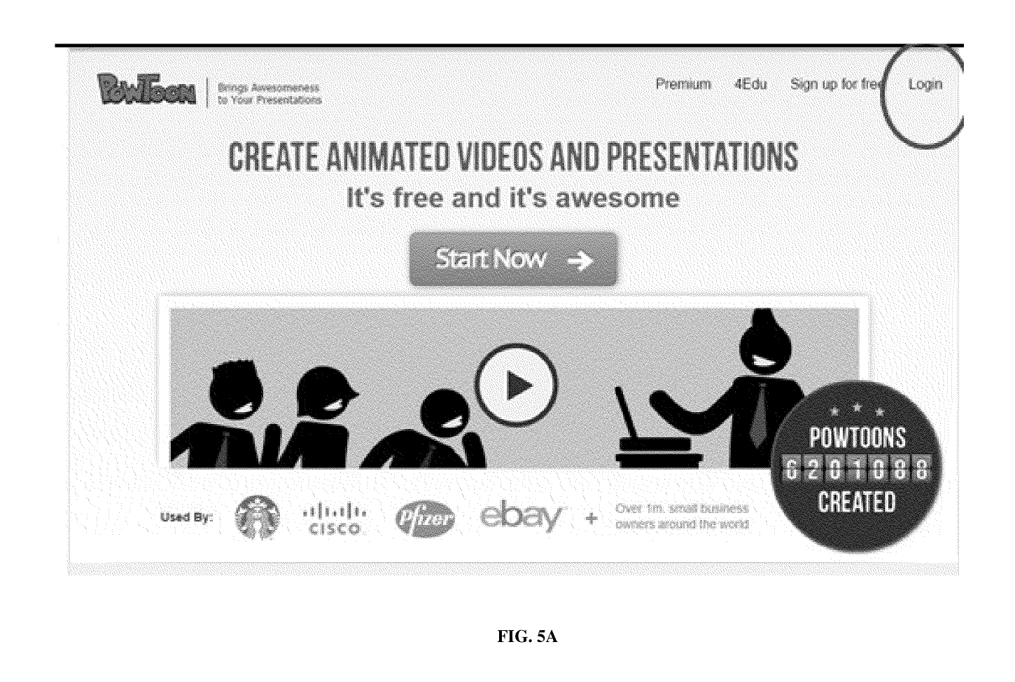

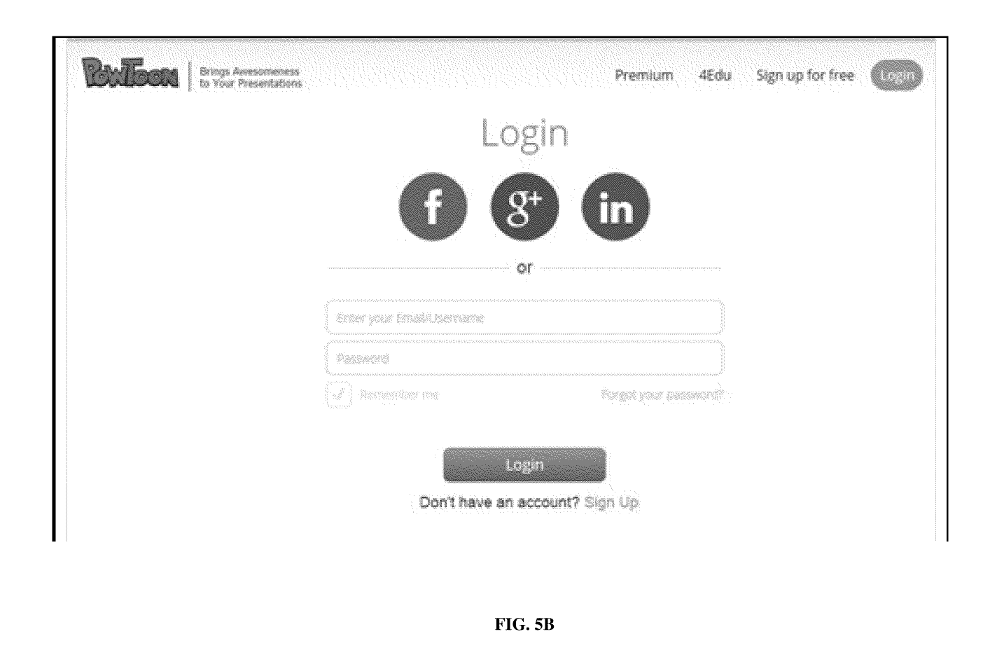

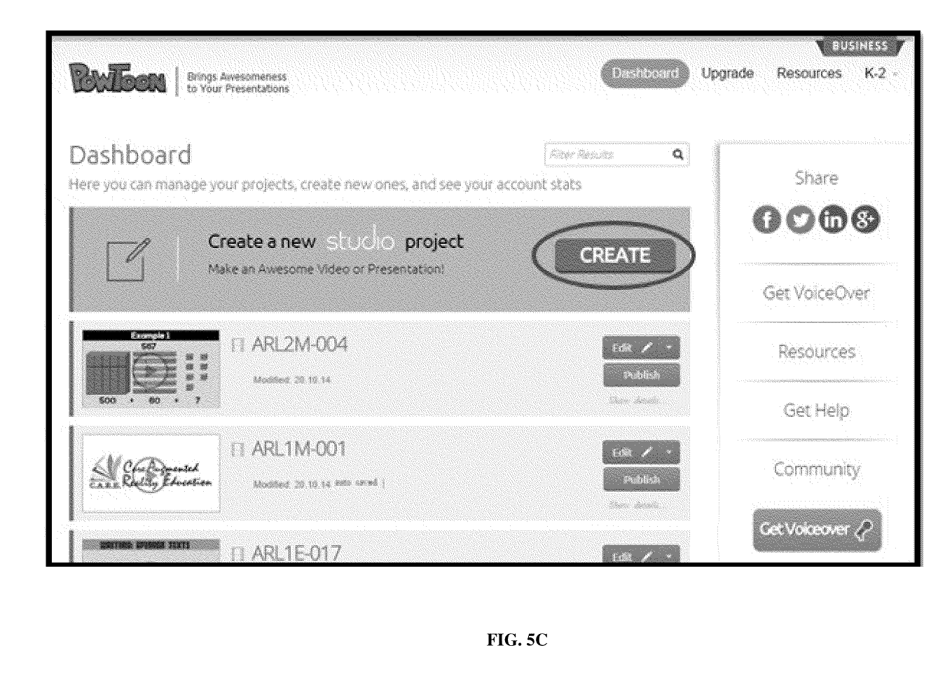

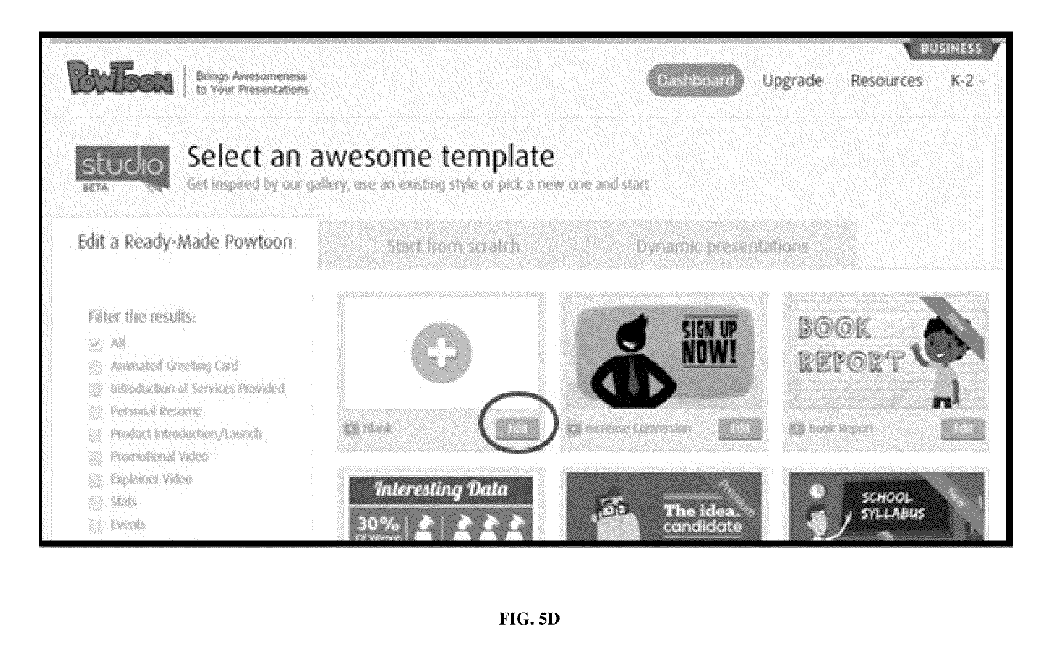

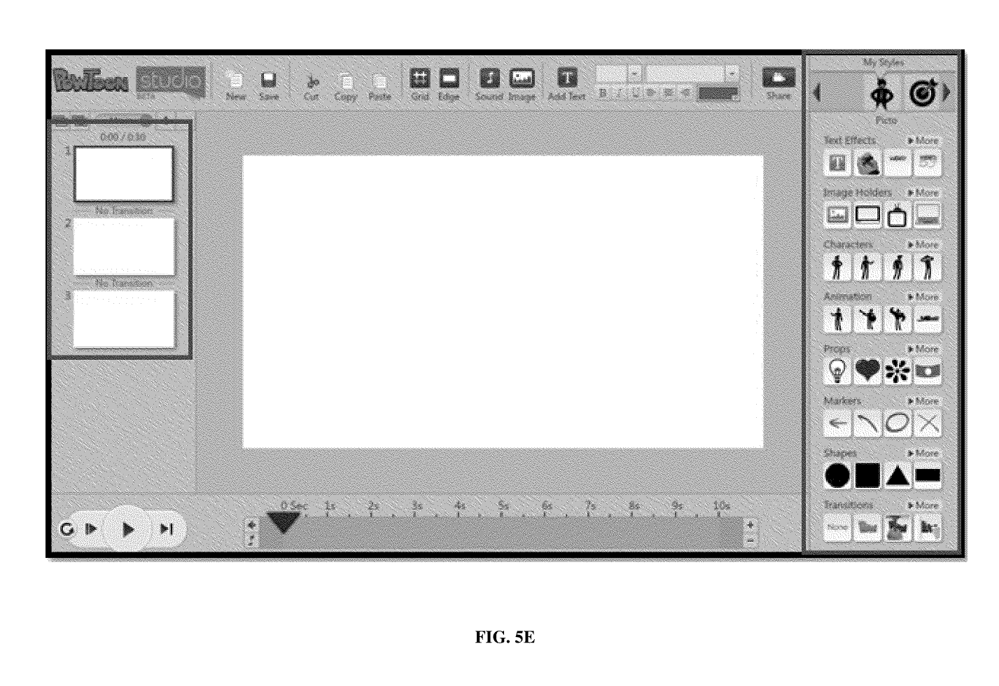

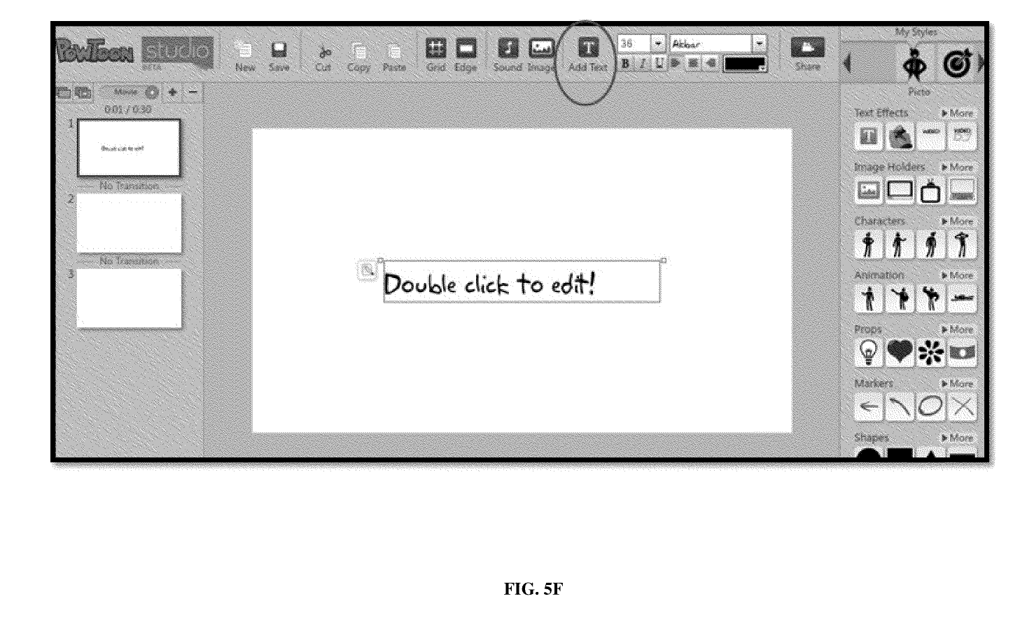

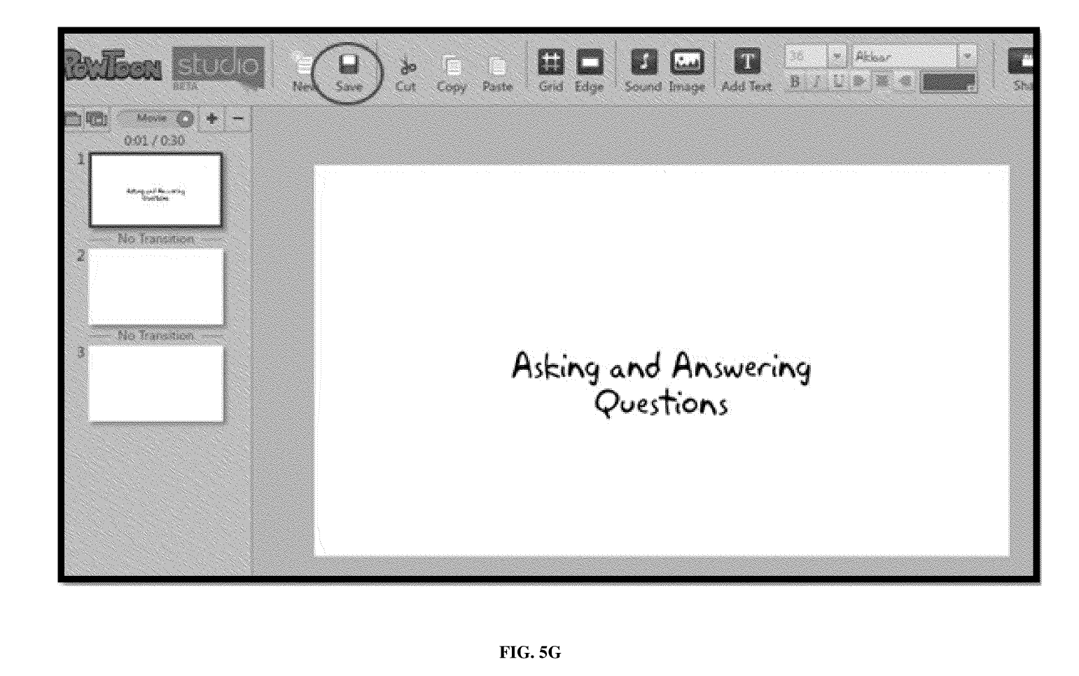

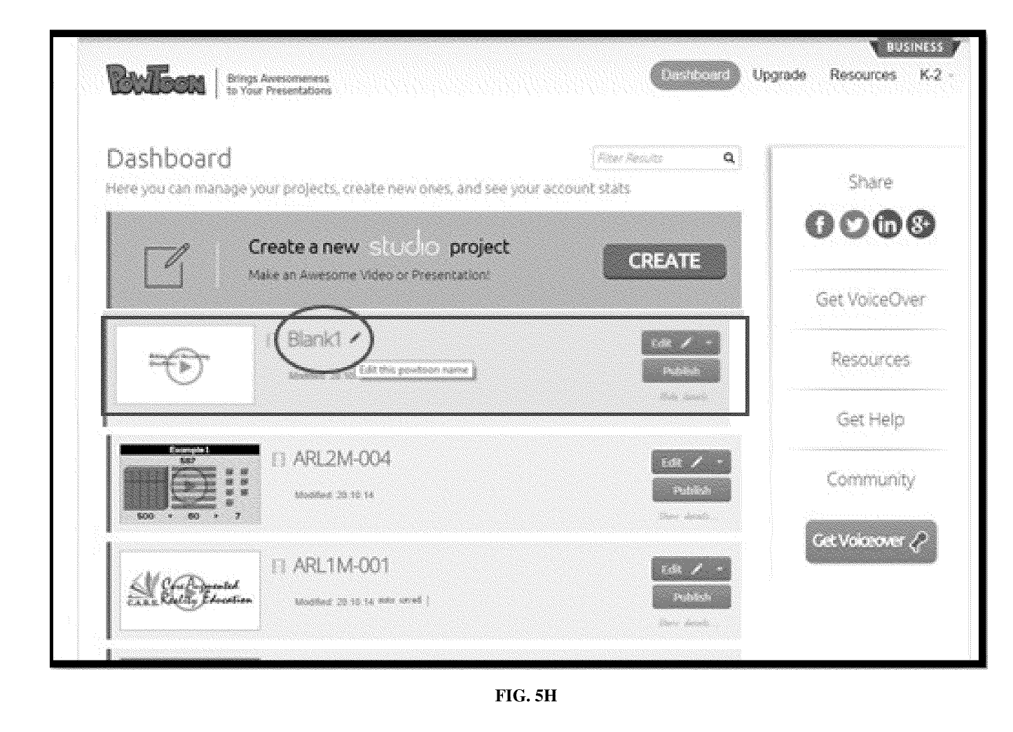

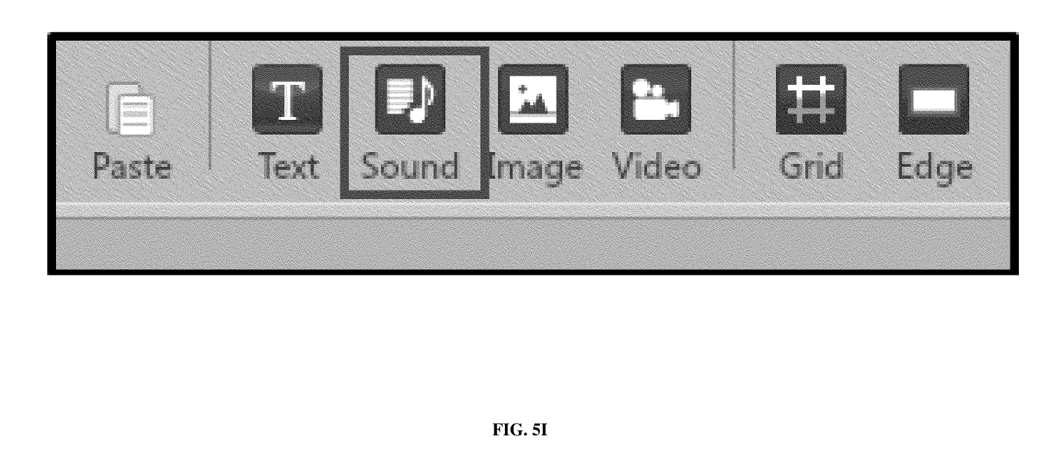

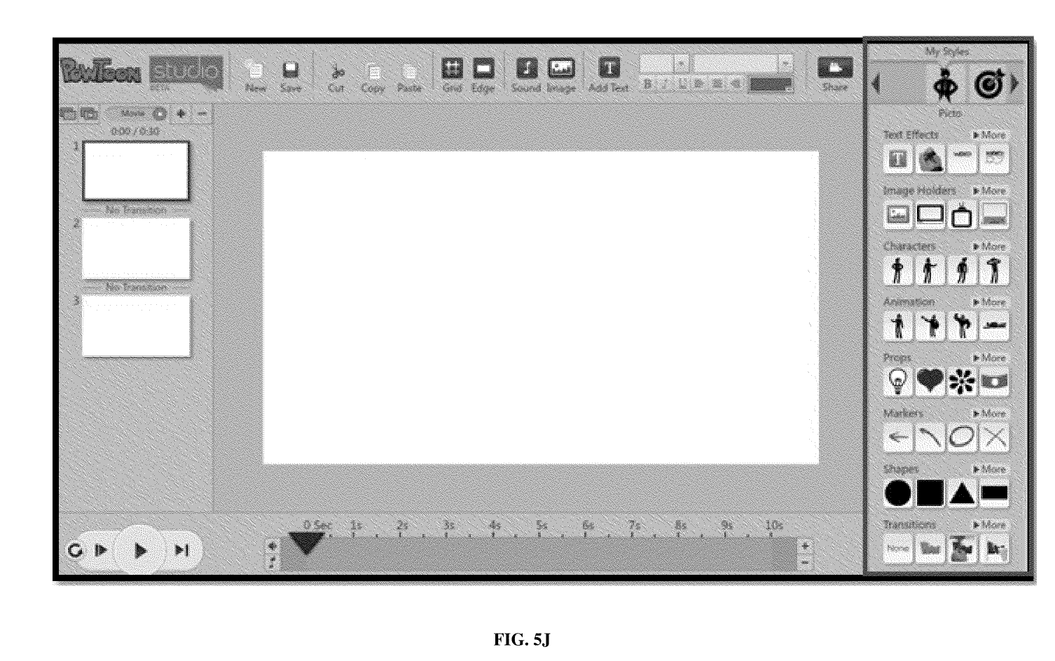

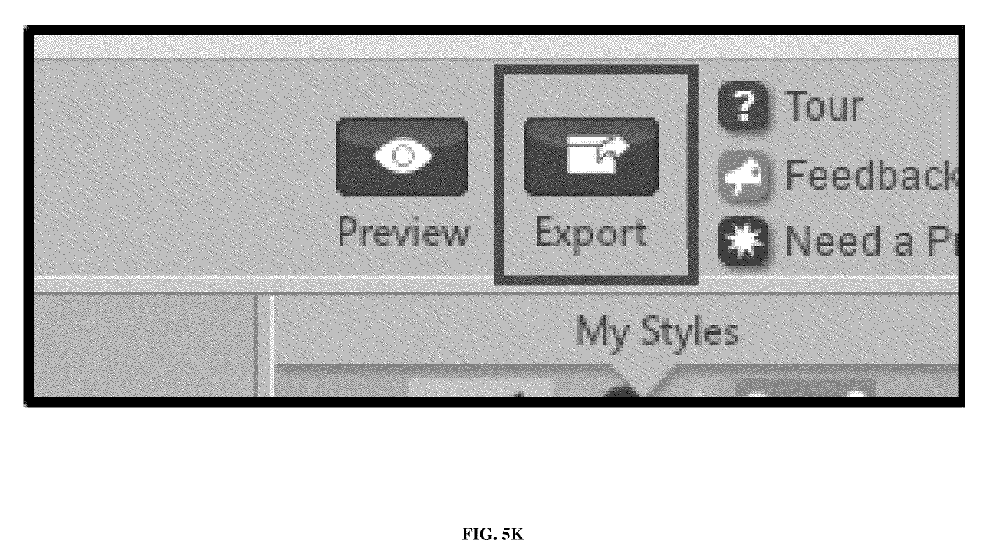

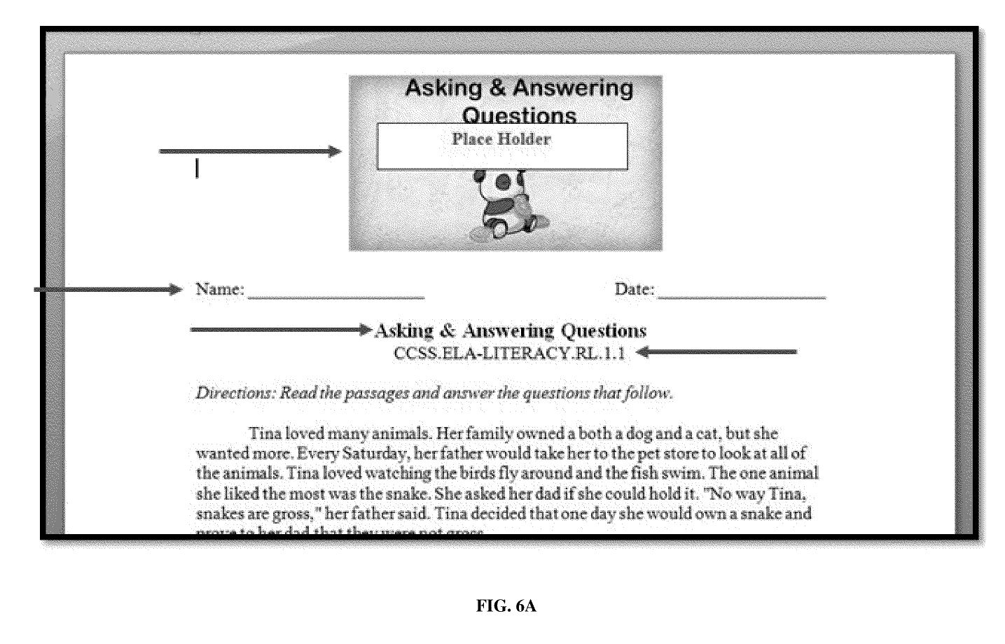

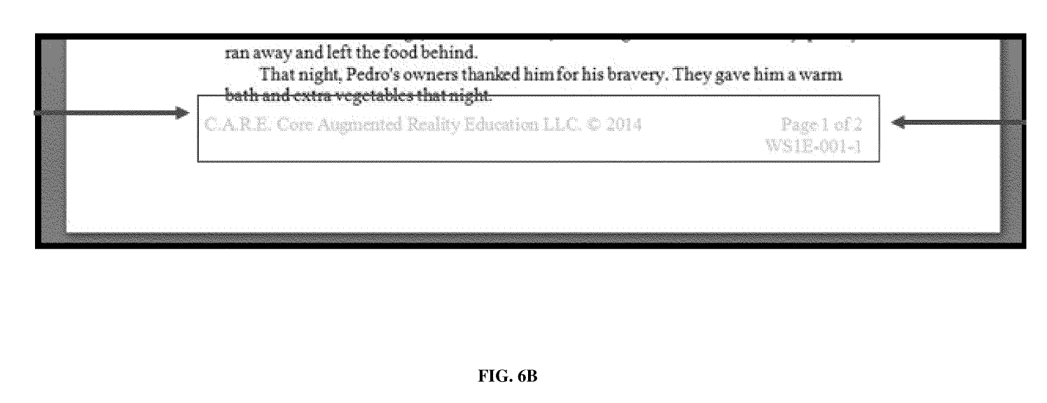

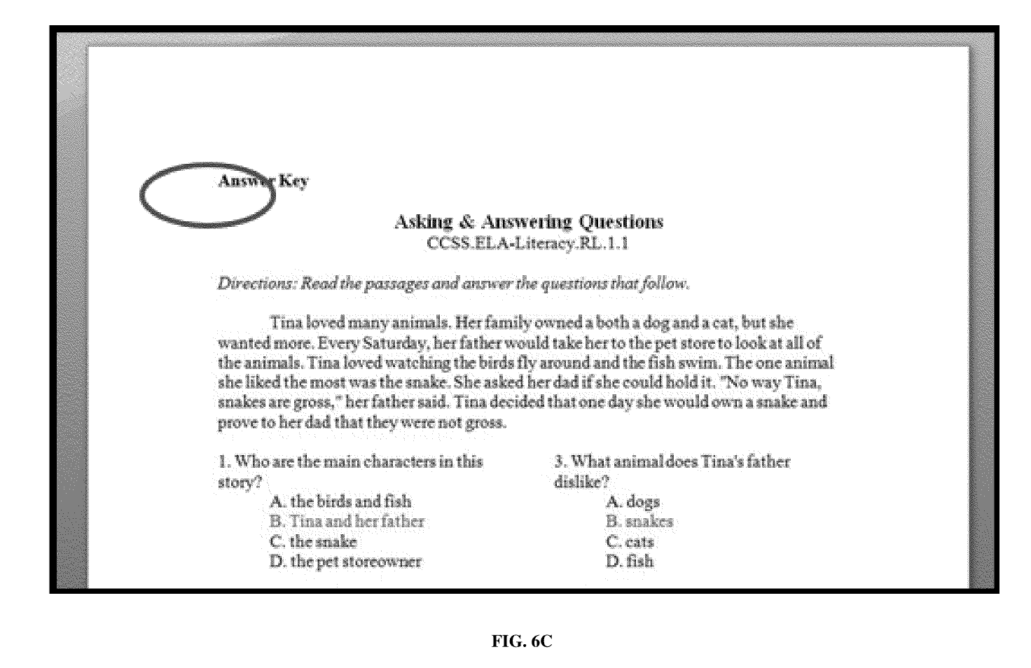

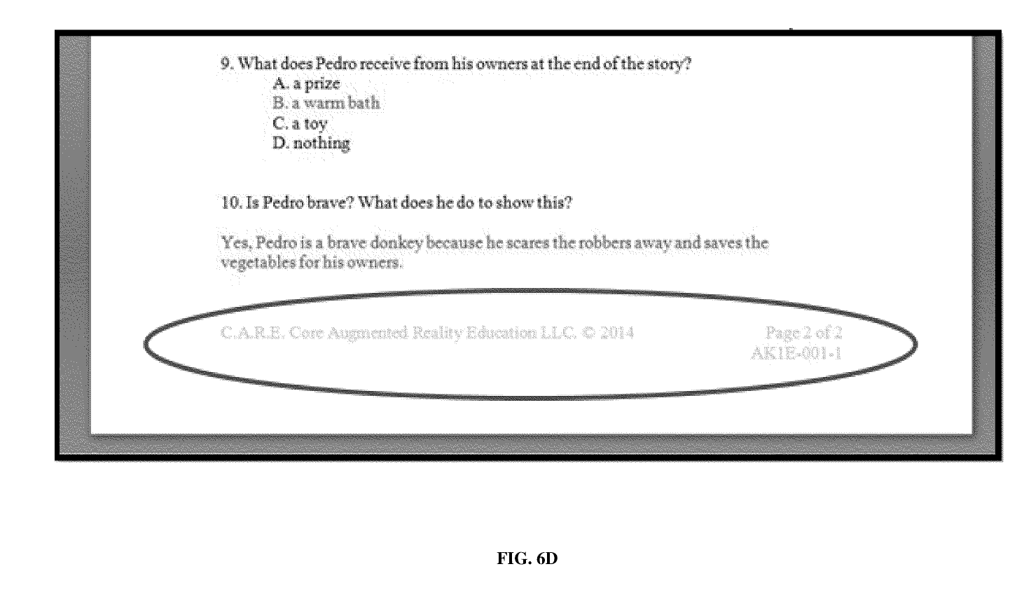

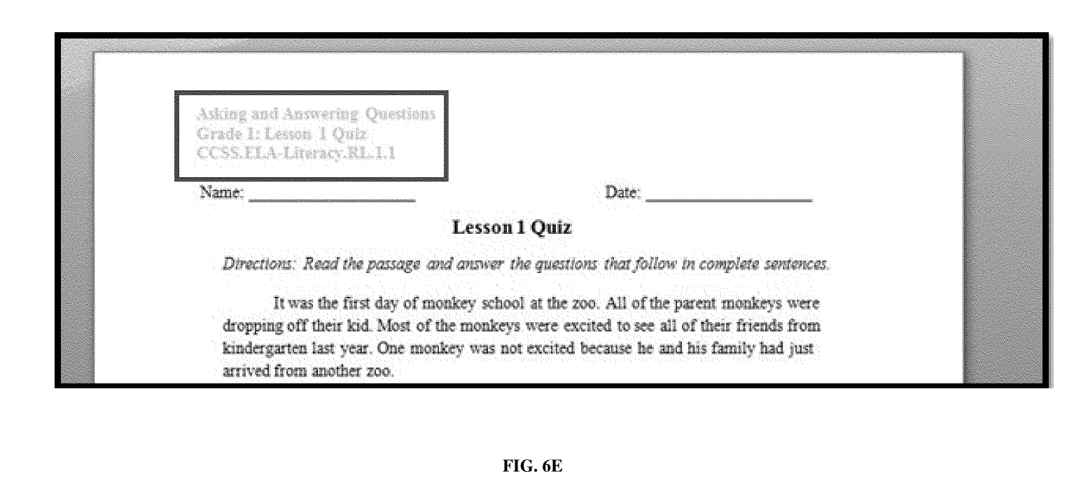

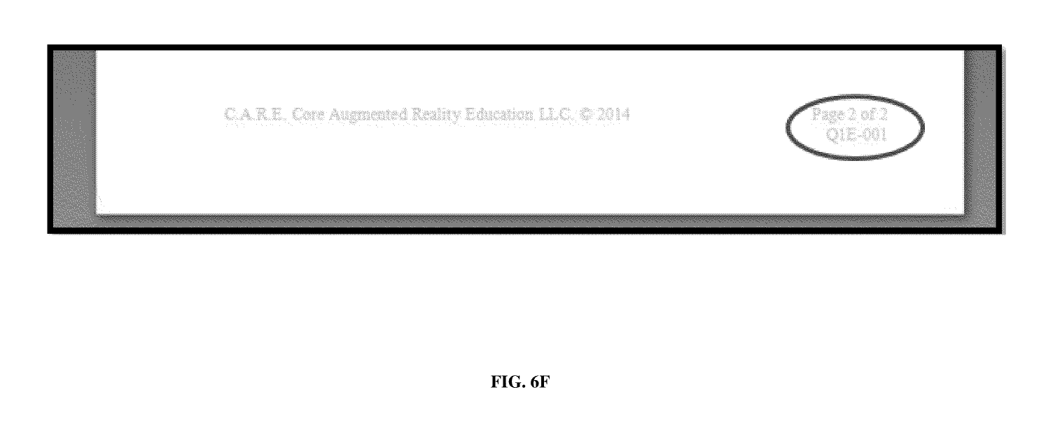

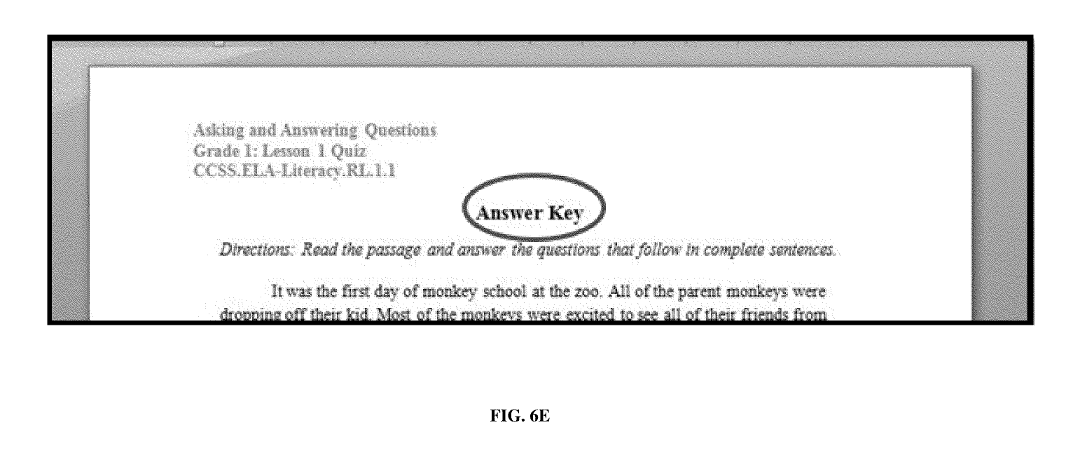

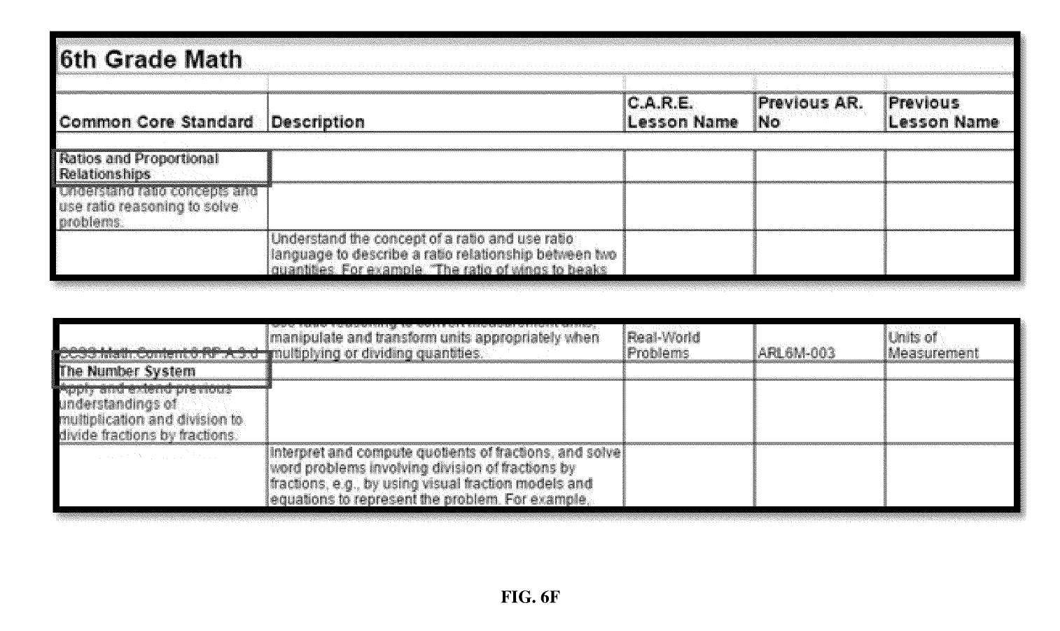

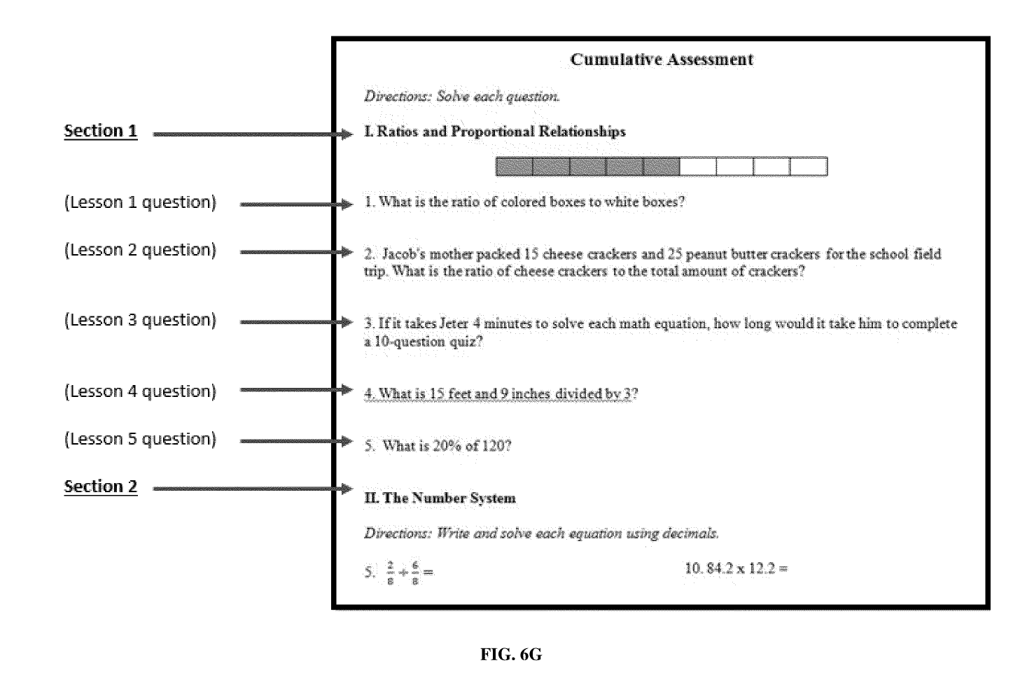

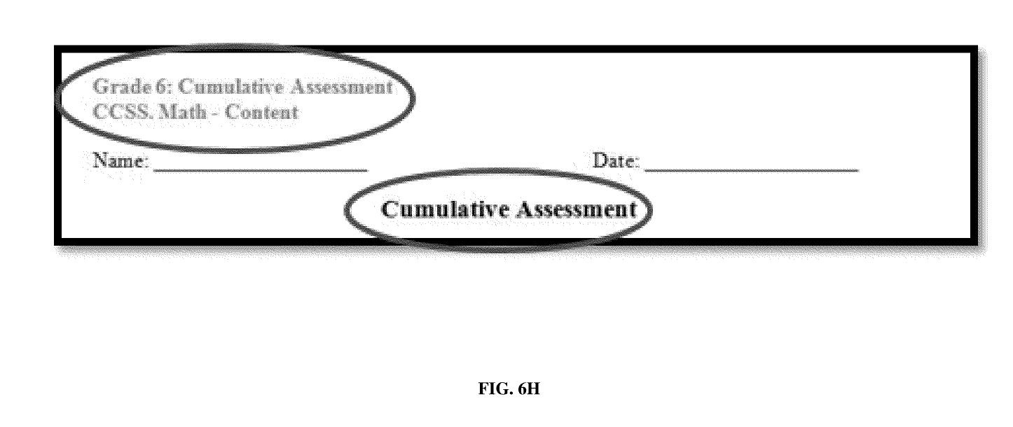

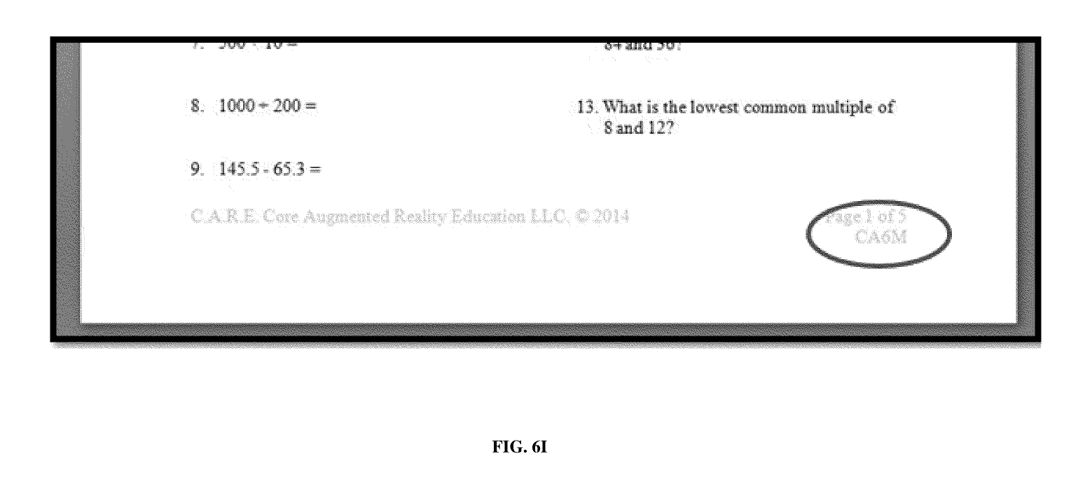

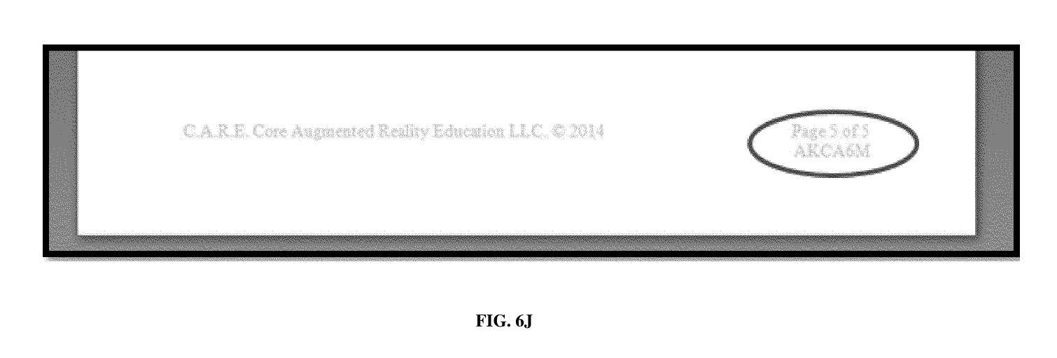

### 3. Educational Materials Creation (See FIGS. 5A-5K)

In a preferred embodiment, a new lesson document is prepared by (1) opening the Predetermined Template file, (2) saving the document as the appropriate lesson name. (e.g. WS2E-001-1), (3) opening and closing a Print Preview dialog box, (4) inserting the appropriate Lesson Title and Lesson Standard into the text fields in the footer, and (5) creating lesson content.

Worksheets are aligned to the specified Common Core Standards. A basic worksheet consists of 10-15 questions that vary from multiple choice to matching to open ended questions or essays. The Heading must consist of the C.A.R.E. Title (size 14 Bold), The Common Core Standard, Name and Date lines, and the Target Image. (If there is not Target Image yet, just use a placeholder and the image will be inserted when complete.) It should also be noted that 10-15 questions are likely required to fill the pages entirely.

Here, the answer key is the same as its worksheet, however the Name and Date and Trigger Image are removed and replaced with the title “Answer Key” in the top left corner. The questions appear the same, just the answers are either marked in red (for multiple choice) or written in red. For open-ended questions, an example answer or possible example answers must be provided. The Footer—the same as the worksheet, however the WS is replaced with an AK.

Quizzes are different from the worksheets in a few ways. First, The Title, Grade info and Standard number are moved to the upper left corner as a header and the color is changed to gray. Further, there is no target image in a quiz. Each quiz should contain 10-15 questions, although they need not be full pages.

Cumulative assessments are a collection of questions collected from each lesson. It is meant to be an assessment of the overall retention of the entire subject (e.g. Math/English) that would be given at the end of the school year. These assessments can range from 35-50 questions, and does not need to be full pages. Preferably, the cumulative assessment is broken up into sections using Roman Numerals. These sections are the black and bold terms that are located on the right most column of in the standards spreadsheet.

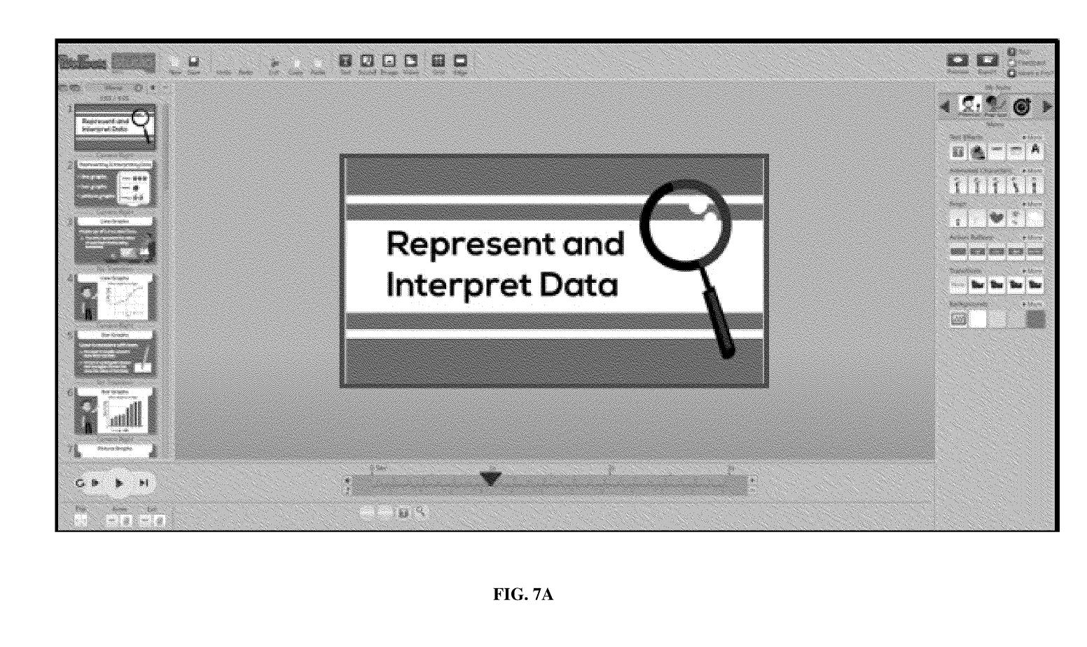

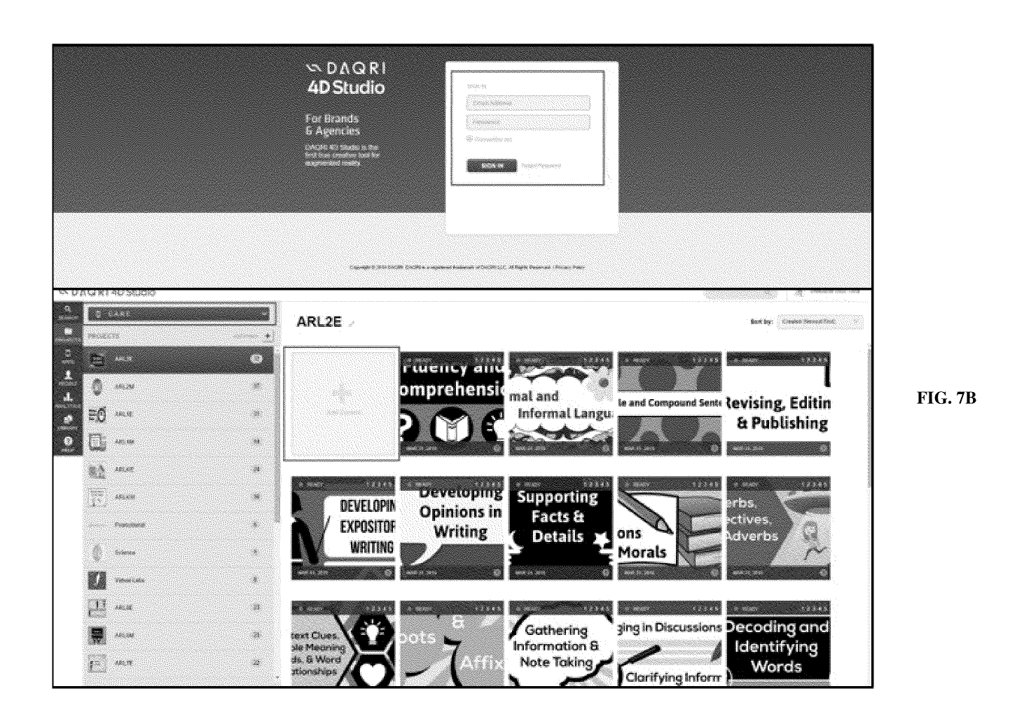

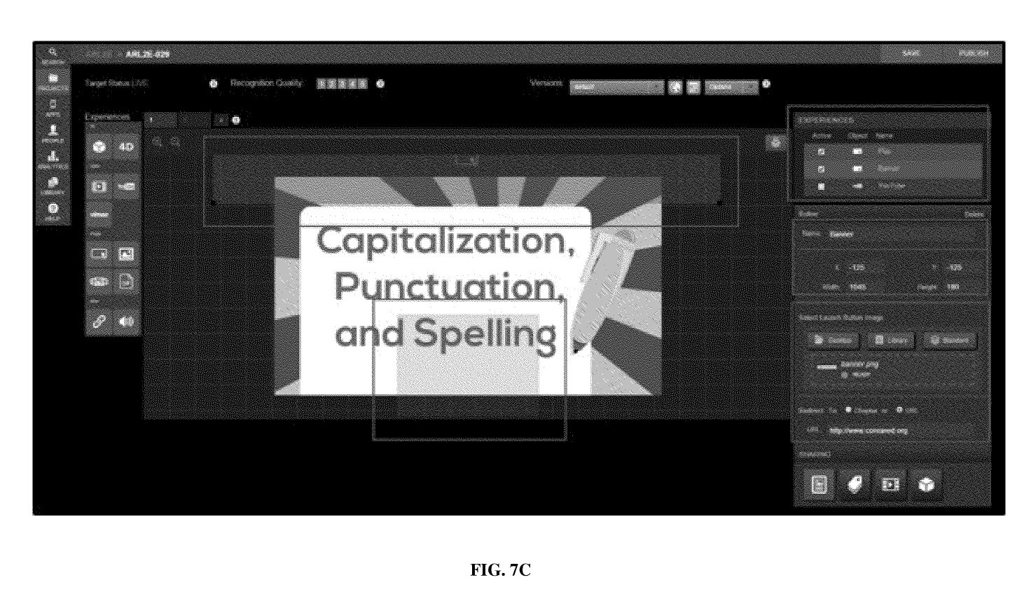

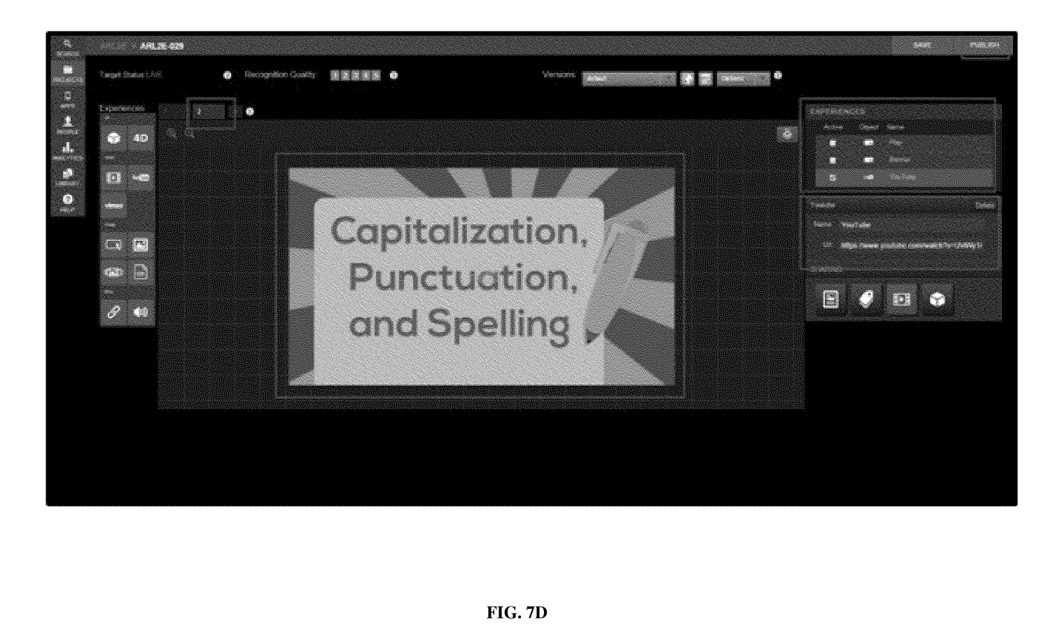

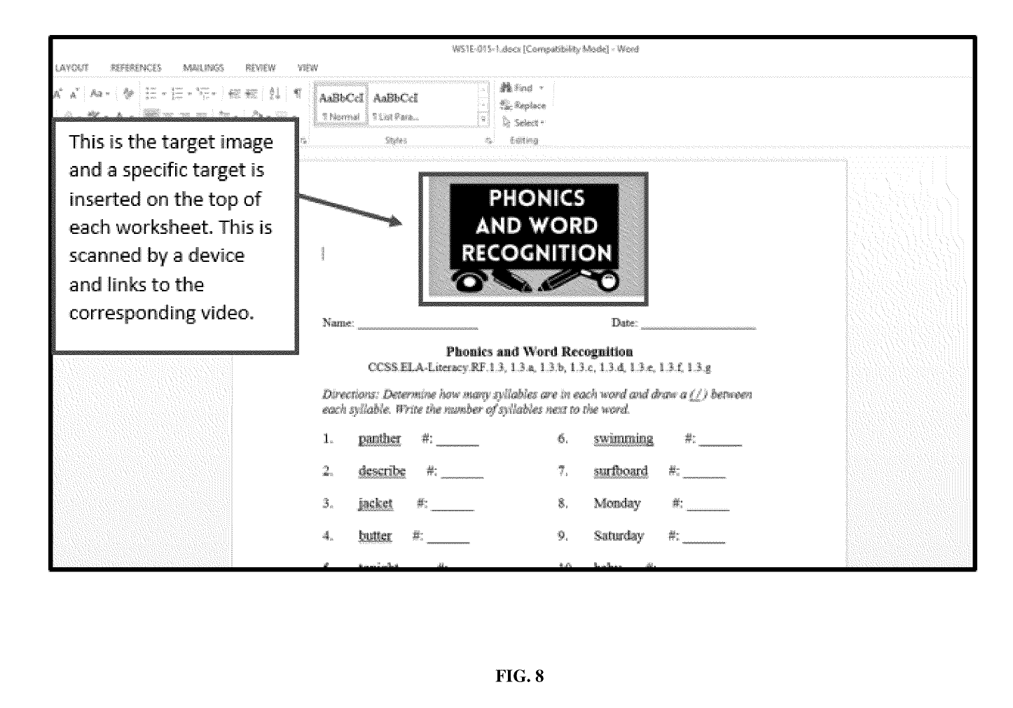

### 4. Target (Trigger) Creation (See FIGS. 7A-7D and FIG. 8)

Once the animated augmented educational content is created, a target image (trigger) is created by taking a screenshot of the first slide of the animated augmented educational content. This screenshot is uploaded into an appropriate augmented reality development studio. For example, DAQRI 4D studio would be suitable for this purpose. The development studio is used to create a link to the animated augmented education content when the trigger is viewed by an appropriate device. While many appropriate devices exist, any device that is capable of overlaying digital content over one's normal view will be appropriate for use with the present invention.

The target image is then added to the top of the corresponding lesson's worksheet.

### 5. Use

Upon the completion of the above steps, the augmented educational content is ready to be consumed by a user. A given user needs to wear a device capable of generating an augmented reality interface, and must be capable of engaging such functionality upon the user viewing the trigger.

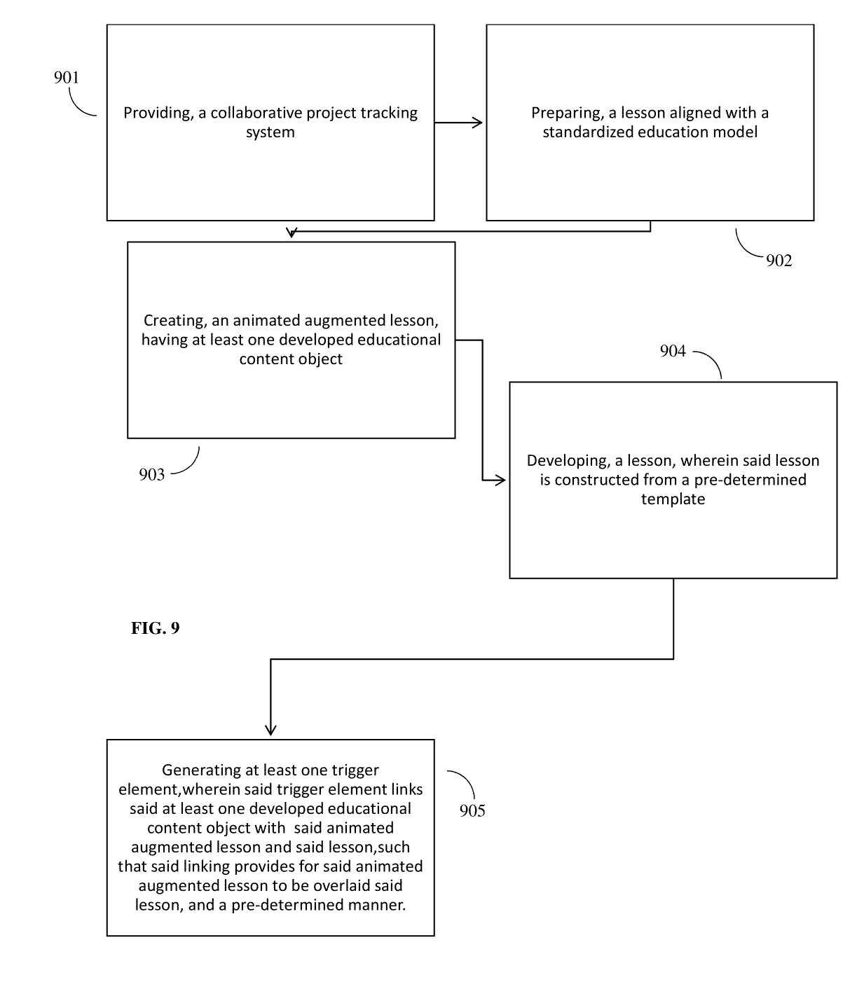

Referring to FIG. 9, an embodiment of the method of generation of augmented educational content of the present invention is provided for. Specifically, in step 901 a real-time collaborative project tracking system is provided for. This allows a number of people to simultaneously generate products in accordance with the invention. For example, there could be an Educator and an Illustrator working together to generate content. In step 902, a lesson is prepared in accordance with some standardized education model. This can be the Common Core, or some other model. In step 903, an animated augmented lesson is created, where at least one developed educational content object is incorporated and said lesson is constructed from a pre-determined template. In step 904, a lesson is developed from a pre-determined template. In step 905, a trigger element is generated. This trigger element, when viewed by an appropriate device, will engage in the deployment of the augmented animated lesson. This is intended to supplement traditional worksheets and similar materials.

An example educator workflow is also provided:

I. Organization & Research
1. Educator reviews/reads the Common Core Standards, Next Generation Science Standards and/or STEM or STEAM guidelines. Educator also may view additional standards or educational content guidelines based on the project in a printed version or from a specified website.
2. Educator applies background knowledge, personal credentials & experience to the given standard grades Preschool through twelfth grade as well as higher education and adult education for Mathematics, English Language Arts, Social Studies, Science, Special Education, English as a Second Language, and English Language Learners, various electives, standardized assessments such as PARC, SAT, GED, and others.
3. Educator references various texts, and outside resources to build their knowledge to begin creating content for C.A.R.E.'s products.

II. Creation and Production: Presentation Software
1. Educator opens and begins developing content within a presentation software, either web based or a stand-alone software. This content is built into a lesson/re-teach/review format for administrators, educators, students, children, adults and parents or guardians.
2. Educator then reviews and edits the content they have created within the presentation software, either web based or stand-alone software.
3. Educator reads and speaks the lesson aloud into a digital recorder. Recordings are of various length depending on the content.
4. Educator plugs the digital recorder into the computer and uploads the file.

III. Creation and Production: Supplemental Materials
1. Educator opens a word document software.
2. Educator titles documents and formats appropriately.
3. Educator develops supplemental materials using their background knowledge, personal credentials, and various references that align with the specific educational content they are working on. Supplemental materials may include; multiple worksheets, quizzes, formative assessments, summative assessments, cumulative assessments, virtual lab materials, activity sheets, flash cards and all corresponding answer keys. Supplemental materials also include those made for the Augmented Reality based 3-D educational software.
4. Educator reviews and edits the content they have created within the word document software.
5. Educator works with an animator to take a snapshot of the title screen from the presentation software to use as a trigger image to be placed on some of the supplemental materials. The trigger image and exported presentation content is then loaded into an Augmented Reality Application Software.

IV. Review, Editing & Publishing
1. Additional educators will review team member's content, offer feedback and work with animators on a loop revision process to finalize the material.
2. Initial educator reviews all content material and finalizes each individual product into a cloud-based storage, server, flash-drive, jump drive, or other media storage device.

V. Final Product/Use
1. Augmented Reality Supplemental Materials. Supplemental materials may include; multiple worksheets, quizzes, formative assessments, summative assessments, cumulative assessments, virtual lab materials, activity sheets, flash cards and all corresponding answer keys. Supplemental materials also include those made for the Augmented Reality based 3-D educational software.
2. Augmented Reality Animated Lessons/Review/Reteach
3. Augmented Workbooks
4. 3-D Holographic Labs/Content
   An example workflow of an animator is now provided:

I. General Media Assets and Research
1. Animators create assets in multimedia editing software on a need basis according to what visualizations the educators foresee necessary for work sheets, animated lessons and the virtual labs along with promotional material and any graphics for C.A.R.E.'s overall identity.
2. All files/assets exchanged on cloud drive, flash drive, or other media storage devices.
3. Animators research non-academic material as needed per project.

II. Creation and Production: Animated Lessons
1. Animators take educator created lessons/content with matching recorded audio and edit them using motion graphics, vector graphics, and audio editing software. They then edit these lessons to be audio synced, clear, and visually appealing animations of various lengths that are aesthetically pleasing, educational, meet standards and cohesively match mapped out grade layout themes.
2. Clear title screen for each lesson is created by Animators to later be used for trigger for augmented reality app and worksheets.
3. Animators cross edit finished lessons created by other animators twice for any oversights or mistakes in alignment, visual pops, typos, etc. Followed by Educator reviews.
4. Animators then export animation from motion graphics software.
5. Using augmented reality application software Animators tie trigger image to the uploaded animated lessons.
6. Animators make the image available to educators to insert in worksheets before publishing.
7. All files and assets the Animators use are exchanged with cloud based storage, flash, server, or other media storage devices.

III. Creation and Production: Virtual Labs
1. Animators meet with educators to discuss content for labs and creatively problem solve together how to best pair visualizations and educational content for the augmented reality based 3D holographic educational interactive virtual labs. They then create outline/plan of action for virtual labs based off of discussion.
2. Animators compile & create assets with photo editing, 3D modeling, and animating software.
3. Additionally an Animator will research any additional information needed to complete labs.
4. An Animator will then upload assets into augmented reality lab software, program assets to paddles, and assign interactions to paddles.
5. Animators demo, test, and implement any and necessary changes in order to create a virtual lab that meets the criteria initially discussed.
6. All files and assets exchanged with cloud based storage, flash, server, or other media storage devices.

IV. Final Product/Use
1. Augmented Reality Supplemental Materials
2. Augmented Reality Animated Lessons/Review/Reteach
3. Augmented Workbooks

All workflow system can be executed and created in using various computer implemented methods and applications. In another embodiment of the invention, the animated augmented lesson could be creating using the Powtoon® service and similar animatronics software's such as Prezi, Keynote, Prezentit, or SlideRocket. In another embodiment the Augmented Reality experience may be rendered from a target that could potentially look different from the present application's design and layout. In another embodiment of the invention, the Technologies, Software, and Environments used may include Unity 3D™, Metaio SDK™, Qualcomm® Vuphoria SDK, C#, Android® SDK, iOS SDK, Xcode, Visual Studio, HTML, HTML5, CSS, Javascript. In another embodiment of the invention, the system may be supported by iOS, Android, Mac, PC, or HTML5.

The present application may have a corresponding application. The application opens to a branded, animated splash-screen that progresses to a menu system. Menu system may contain, but not limited to: an augmented reality (AR) Viewfinder, External Links to websites, files, communication, and other apps, user Contact information, Instructional information, Internal files, media library and application information and settings. Features of the Application may include, but not limited to: manipulating 3D and 2D models from an internal library or external source(this would include moving, scaling, rotating, coloring, and lighting), tracking AR targets and rendering internal or external content from a server, viewing media such as videos, animated models, text, and audio; touch interaction with menu systems, 3D and 2D models, and entire interactive environments, haptic, visual, and audio feedback, and the augmentation of reality by overlaying all previously stated content, interactions on to a camera feed. In another embodiment of the invention, the application's menu items and features may include, but not limited to: an about page, user login Page, user account information, account management, content caching or downloading, content uploading to social media or custom repository, news/updates provided by us, allow content creation and sharing, and multi-device Interaction

In another embodiment of the present invention, the system may be integrated with other complimentary technologies such as, but not limited to: AR and VR Headsets, Gesture Monitoring, and Body and Environment Sensors and similar technologies. In another embodiment of the invention, content, and its creation, will be user friendly wherein the experience and application are social and sharable. In this embodiment of the invention, larger scoped experiences may be created in which multiple users could interact dynamically and in real time. In another embodiment of the present invention, the system may be touchless, wearable, comprise body and environment sensors and targets may be smaller or even nonexistent. In another embodiment of the present invention, the technology will be applied to more daily activities wherein the user base will be more inclined to use it and more educated on its applications. In another embodiment of the invention, the system and methods may be executed on a custom built augmented reality application (viewer) that will enable users to view AR experiences and content. In a further embodiment, the system and methods may be adapted to allow students to create experiences based on a predetermined framework and instructions.

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present ivention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present ivention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present inveniton), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the cooling chest system, including temperature sensors, ice dispensers (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, ice maker, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU.

The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invnetion.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship. Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof.

Therefore, it is intended that the disclosure not be limited to the particular embodiments disclosed.

What is claimed is:

1. A computer implemented method for generating educational content, comprising memory that stores computer-executable instructions; and a processor, communicatively coupled to the memory that facilitates execution of the computer-executable instructions comprising the steps:
providing, a collaborative project tracking system;
preparing, a lesson aligned with a standardized education model;
creating, an animated augmented lesson, having at least one developed educational content object;
developing, a lesson,
wherein said lesson is constructed from a pre-determined template;
generating at least one trigger element,
wherein said trigger element links said at least one developed educational content object with said animated augmented lesson and said lesson, such that said linking provides for said animated augmented lesson to be overlaid said lesson, and a pre-determined manner.

2. The method of claim 1, wherein said project tracking system comprises a real-time collaborative spreadsheet.

3. A method of displaying educational content, comprising the steps of:
receiving, at least one item of educational media content, a set of criteria, and optionally an update to said at least one item of educational media content;
developing, at least one educational content object using said received educational media content;
generating, a trigger element for each of said at least one item of educational media content;
receiving, said trigger element and said at least one developed educational object from said content development application via an augmented reality application;
receiving, at least one item of additional information;
generating, media assets from said at least one developed educational content object and said at least one item of additional information;
creating, at least one item of augmented educational content;
displaying, said at least one item of augmented educational content, via an augmented reality display device.

4. The method of claim 3, wherein said set of criteria is education criteria associated with said at least one item of educational media content, via a content development application.

5. The method of claim 3, wherein said educational content object is developed in more than one format and wherein said at least one item of augmented education content is created in more than one format.

6. The method of claim 3, wherein said at least one item of additional information is received from at least one animation source.

7. An augmented educational content management system, comprising:
memory that stores computer-executable instructions; and a processor, communicatively coupled to the memory that facilitates execution of the computer-executable instructions; comprising:
at least one item of educational media content;
updates to said at least one item of educational media content, if available;
a set of educational criteria;
a content development application,
wherein said content development application is capable of receiving said at least one item of educational media content, said updates to said at least one item of educational media content, and set of educational criteria, and
wherein said content development application is capable of generating at least one educational content object, at least one trigger element capable of assessing to at least one associated developed educational content object;
an augmented reality application,
wherein said augmented reality application is capable of receiving said at least one educational content object, at least one trigger element, at least one associated developed education content object, and at least one item of additional information,
wherein said augmented reality application is also capable of generating at least one media asset based on said at least one educational content object, at least one trigger element, at least one associated developed education content object, and said at least one item of additional information;
at least one item of augmented educational content, generated from said at least one media asset; and
an augmented reality display device, capable of displaying said at least one item of augmented educational content.

8. The augmented educational content management system of claim 7, wherein said at least one item of educational media content is selected from the group consisting of textual content, audio content, audiovisual content, image content, and multimedia content.

9. The augmented educational content management system of claim 7, wherein said set of educational criteria is selected from the group consisting of the Common Core standard, Next Generation Science standards, Guided Language Acquisition Design, Science Technology, Engineering, and Mathematics guidelines, and Science, Technology, Engineering, Art, and Mathematics guidelines.

10. The augmented educational content management system of claim 7, wherein said content development application is hosted on an external server and accessed remotely.

11. The augmented educational content management system of claim 7, wherein said updates to said educational media content comprise reviews and edits to said educational media content.

12. The augmented educational content management system of claim 7, wherein said at least one educational content object comprise multiple worksheets, quizzes, formative assessments, summative assessments, cumulative assessments, virtual lab materials, activity sheets, flash cards, corresponding answer keys, or any combination thereof.

13. The augmented educational content management system of claim 7, wherein said at least one trigger element comprises an image, a link, an icon, a QR code, or any combination thereof.

14. A workflow system, comprising:
memory that stores computer-executable instructions; and a processor, communicatively coupled to the memory that facilitates execution of the computer-executable instructions; comprising the steps of:
reviewing, a standardized educational model by a first educator;
applying, pertinent background knowledge by said first educator;
referencing, various texts and at least one outside resource;
developing content, by said first educator, via software;
reviewing and editing said content;
speaking and recording said content, into a recording device, generating a recording;
uploading said recording to an external server;
developing supplemental materials, having a title screen, by said first educator;
reviewing said supplemental materials;
taking, a snapshot of said title screen;
generating a trigger image and at least one item of presentation content based on said snapshot;
uploading said presentation content to a software program;
reviewing said presentation content by a second educator;
reviewing said presentation content by said first educator;
placing said presentation content into a media storage device.

15. A workflow system, comprising:
memory that stores computer-executable instructions; and a processor, communicatively coupled to the memory that facilitates execution of the computer-executable instructions; comprising the steps of, comprising the steps of:
creating assets, in multimedia editing software by a first animator;
optionally researching, non-academic material by said first animator;
editing, educator-created content using motion graphics, vector graphics, and audio editing software;
syncing, said graphics with an audio track creating, a title screen and at least one animation;
reviewing, said at least one animation, by a second animator, exporting, said at least one animation;
tying, a trigger image to said at least one animation;
uploading, said trigger image to an external server. creating, a plan of action for a virtual lab;
creating, assets, by said first animator;
testing said at least one asset;
uploading, at least one asset to said external server.
